(19) United States
(12) Patent Application Publication
(10) Pub. No.: US 2021/0344064 A1
(43) Pub. Date: Nov. 4, 2021

(54) Battery Module

(71) Applicant: Electric Era Technologies Inc., Seattle, WA (US)

(72) Inventor: Elliot Owen, Seattle, WA (US)

(73) Assignee: Electric Era Technologies Inc.

(21) Appl. No.: 17/245,350

(22) Filed: Apr. 30, 2021

Related U.S. Application Data
(60) Provisional application No. 63/018,202, filed on Apr. 30, 2020.

(51) Int. Cl. H01M 10/6568; H01M 10/48; H01M 10/613; H01M 10/643; H01M 50/213; H01M 10/6557

(52) U.S. Cl. CPC H01M 10/6568; H01M 10/486; H01M 10/482; H01M 10/6557; H01M 10/643; H01M 50/213; H01M 10/613

(57) ABSTRACT

A battery module is provided herein. The battery module can include a retainer assembly having a well plate operably coupled with a substrate. The well plate can define one or more battery cell cavities on an exterior side of the well plate. One or more channels can be defined between an interior side of the well plate and an upper side of the substrate. One or more battery cells can be positioned within the one or more battery cell cavities. A first manifold can define one or more fluid outlets configured to direct a fluid through the one or more channels. A second manifold can define one or more fluid inlet passages configured to receive fluid from the one or more channels. A cooling system can be fluidly coupled the second manifold to the first manifold.

### CROSS-REFERENCE TO RELATED APPLICATION

This application is a non-provisional application claiming the benefit of priority under 35 U.S.C. § 119(e) to U.S. Provisional Application No. 63/018,202, filed Apr. 30, 2020, which is hereby incorporated by reference in its entirety.

### FIELD

The present disclosure generally relates to battery modules that can be used for housing one or more battery cells.

### BACKGROUND

Battery modules are applicable to a wide range of products and have electrical characteristics with high energy (and power) density. The battery modules can include one or more battery cells that are applied not only to portable electronic devices but also to electric vehicles, hybrid vehicles, electric power storage devices, and the like.

Battery modules continue to increase in usage due to their aptitude for improving environmental-friendliness and energy efficiency in that they have not only a primary advantage of reducing the use of fossil fuels but also generate no by-product due to the use of energy. For instance, a battery pack applied to an electric vehicle has a structure in which a plurality of battery modules, each including one or more battery cells, are connected to obtain a high output. In addition, each battery cell includes positive and negative electrode collectors, a separator, an active material, and an electrolyte as an electrode assembly and allows repeated charging and discharging by an electrochemical reaction between the components.

However, since the battery pack is manufactured in a manner that the plurality of battery modules are densely packed in a narrow space, it is important to release the heat generated during the usage of the battery module. That is, during the process of charging or discharging the battery module, heat is generated due to electrochemical reactions and ohmic losses. Thus, if the heat of the battery module generated during the charging and discharging process is not effectively removed, heat accumulation may occur. In addition, the deterioration of the battery module may be accelerated, and, in some cases, ignition or explosion may occur.

Further, since the heating amount of the battery cell is proportional to the square of the current, the temperature of the battery cell is likely to rise sharply during high-rate discharge. In particular, the heat island phenomenon, where the heat is concentrated in a central portion of the array structure of battery cells loaded in the battery module, is likely to occur. If the heat island phenomenon occurs for a longer period of time, the output voltages of battery cells electrically connected in parallel are not uniform, resulting in battery cell imbalance, and thus it is difficult for the battery module to give its performance. Further, linear temperature gradients along the direction of cooling flow can be more severe and cause parallel groups of battery cells to have different voltages. If the first (coldest) cell and a last cell (hottest) are all discharging, then the battery will be limited by the first cell hitting an undervoltage limit. Therefore, a technology capable of effectively cooling and improving a heat balance is needed in order to improve the performance and lifetime of the battery module.

### SUMMARY

Aspects and advantages of the invention will be set forth in part in the following description, or may be obvious from the description, or may be learned through practice of the invention.

According to some aspects of the present disclosure, a battery module includes a retainer assembly including a well plate operably coupled with a substrate. The well plate defines one or more battery cell cavities on an exterior side of the well plate. One or more channels are defined between an interior side of the well plate and an upper side of the substrate. One or more battery cells are positioned within the one or more battery cell cavities. A first manifold defines one or more fluid outlets configured to direct a fluid through the one or more channels. Each of the one or more channels can include a non-uniform cross section in a longitudinal direction. A second manifold defines one or more fluid inlet passages configured to receive fluid from the one or more channels. The second manifold is downstream of the first manifold in an X-axis direction. The first manifold is a first minimum distance from at least one of the one or more battery cells and the second manifold is a second minimum distances from at least one of the one or more battery cells. The second distance is less than the first distance. A cooling system is fluidly coupling the second manifold to the first manifold.

According to some aspects of the present disclosure, a method of manufacturing a battery module having a cooling system includes forming a well plate defining one or more battery cell cavities surrounded by a non-linear outer wall. The one or more battery cell cavities each define a coupling portion. The outer wall defines a joining portion with the joining portion having a thickness that is varied from a thickness of the coupling portion. The method further includes coupling the well plate to a substrate.

According to some aspects of the present disclosure, a retainer assembly for a battery module includes a substrate. A well plate is operably coupled with the substrate. The well plate defines one or more battery cell cavities on an exterior side of the well plate. The one or more battery cell cavities define first and second channels between an interior side of the one or more battery cell cavities and the substrate. An outer wall has a non-planar shape that surrounds at least the first and second channels.

These and other features, aspects, and advantages of the present technology will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 is a top isometric view of a battery module, according to some aspects of the present disclosure;

FIG. 2 is a graph illustrating the correlation between a relative capacity of a battery cell to storage state of charge over time at various temperatures, according to some aspects of the present disclosure;

FIG. 3 is a top plan view of the battery module include a retainer assembly and a cooling system, according to some aspects of the present disclosure;

FIG. 4 is a bottom perspective view of the retainer assembly including a plurality of ribs interconnecting various battery cell cavities, according to some aspects of the present disclosure;

FIG. 5 is a cross-sectional view of the retainer assembly of FIG. 3 taken along the line V-V.

FIG. 6 is a cross-sectional view of the retainer assembly of FIG. 3 taken along the line VI-VI.

FIG. 7 is a cross-sectional view of the retainer assembly of FIG. 3 taken along the line VII-VII.

FIG. 8 is a bottom perspective view of the retainer assembly, according to some aspects of the present disclosure;

FIG. 9 is a front plan view of the retainer assembly, according to some aspects of the present disclosure;

FIG. 10 is a rear plan view of the retainer assembly, according to some aspects of the present disclosure;

FIG. 11 is a graph illustrating the effect of battery cell cavity wall thickness on thermal performance, according to some aspects of the present disclosure;

FIG. 12 is a graph illustrating the impact of draft angle on thermal performance, according to some aspects of the present disclosure;

FIG. 13 is a graph illustrating the sensitivity of the thermal resistance network to the “cooled height” of the battery cell, according to some aspects of the present disclosure;

FIG. 14 is a flowchart illustrating a method of manufacturing the battery module, according to some aspects of the present disclosure;

FIG. 15 is a top perspective view of the battery module, according to some aspects of the present disclosure;

FIG. 16 is an exploded perspective view of the battery module, according to some aspects of the present disclosure;

FIG. 17 is an enhanced view of area XVII of FIG. 15, according to some aspects of the present disclosure;

FIG. 18 is a top perspective view of the well plate of the retainer assembly, according to some aspects of the present disclosure;

FIG. 19 is a bottom plan view of the well plate of the retainer assembly, according to some aspects of the present disclosure;

FIG. 20 is a perspective cross-sectional view of the well plate taken along the line XX-XX of FIG. 19;

FIG. 21 is a bottom partial perspective view of the well plate, according to some aspects of the present disclosure;

FIG. 22 is a side partial perspective view of the well plate, according to some aspects of the present disclosure;

FIG. 23 is a perspective cross-sectional view of the well plate taken along the line XXIII-XXIII of FIG. 16;

FIG. 24 is an enhanced view of area XXIV of FIG. 23;

FIG. 25 is a bottom partial perspective view of the well plate, according to some aspects of the present disclosure;

FIG. 26 is a top perspective view of the well plate housing a plurality of battery cells, according to some aspects of the present disclosure;

FIG. 27 is a bottom plan view of the well plate housing a plurality of battery cells, according to some aspects of the present disclosure;

FIG. 28 is a cross-sectional view of the well plate and the substrate taken along the line XXVIII-XXVIII of FIG. 26; and

FIG. 29 is a flowchart illustrating a method of manufacturing the battery module, according to some aspects of the present disclosure.

Repeat use of reference characters in the present specification and drawings is intended to represent the same or analogous features or elements of the present technology.

### DETAILED DESCRIPTION OF THE PREFERRED EXAMPLES

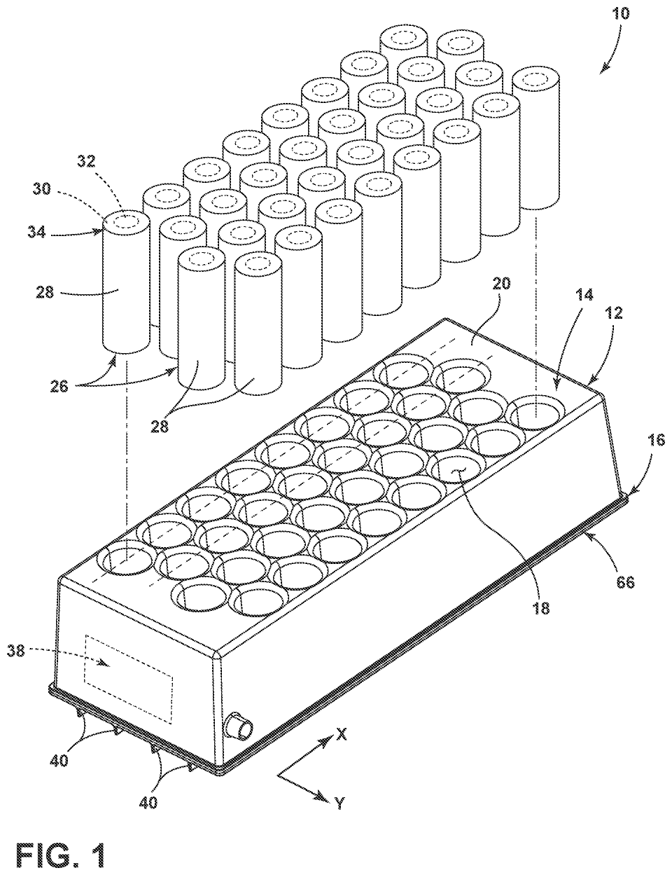

For purposes of description herein, the terms “upper,” “lower,” “right,” “left,” “rear,” “front,” “vertical,” “horizontal,” and derivatives thereof shall relate to the embodiment of the invention as oriented in FIG. 1. However, it is to be understood that the invention may assume various alternative orientations, except where expressly specified to the contrary. It is also to be understood that the specific devices and processes illustrated in the attached drawings and described in the following specification are simply exemplary examples of the inventive concepts defined in the appended claims. Hence, specific dimensions and other physical characteristics relating to the examples disclosed herein are not to be considered as limiting, unless the claims expressly state otherwise.

As required, detailed examples of the present invention are disclosed herein. However, it is to be understood that the disclosed examples are merely exemplary of the invention that may be embodied in various and alternative forms. The figures are not necessarily to a detailed design and some schematics may be exaggerated or minimized to show a function overview. Therefore, specific structural and functional details disclosed herein are not to be interpreted as limiting, but merely as a representative basis for teaching one skilled in the art to variously employ the present invention.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “and/or,” when used in a list of two or more items, means that any one of the listed items can be employed by itself, or any combination of two or more of the listed items can be employed. For example, if any assembly or composition is described as containing components A, B, and/or C, the assembly or composition can contain A alone; B alone; C alone; A and B in combination; A and C in combination; B and C in combination; or A, B, and C in combination.

In general, the present subject matter is directed to systems and methods for cooling a battery module that includes one or more battery cells. The one or more battery cells are capable of high-power discharge but are often thermally limited in their performance. At elevated temperatures, battery cells degrade and lose energy capacity as well as pose a safety risk. Maintaining low temperatures at high power levels is a complex electrical-mechanical-thermal problem in which the core challenge is to remove heat from a battery cell and transfer it into a fluid (e.g., a coolant) while maintaining electrical isolation between the battery cell and fluid. Furthermore, the interface must also be mechanically robust and amenable to existing manufacturing processes. The battery module provided herein satisfies these electrical, mechanical, and fluid problems at a reasonable cost to unlock the use of various types of battery cells for high power per dollar applications such as peak shaving energy storage systems.

In several embodiments, the battery module provided herein includes a retainer assembly having a well plate operably coupled with a substrate. The well plate defines one or more battery cell cavities on an exterior side of the well plate. Each of the battery cell cavities may be configured to house a respective battery cell. In various examples, the battery cells may be retained in the cavities through an adhesive, mechanical retainment, or any other practicable method of attachment.

In addition, in various embodiments, one or more channels are defined between an interior side of the well plate and an upper side of the substrate. The one or more channels can extend both between a bottom portion of the battery cell cavities and between the battery cell cavities. A cooling system can be configured to direct a fluid through the one or more channels such that the fluid flows both under each of the battery cells and around at least a portion of the sides of the battery cells.

In some instances, each latitudinal row of battery cells may be offset from the longitudinally adjacent row of battery cells. Such an orientation may allow for smaller packaging and can make each of the one or more channels non-uniform, non-planar, convoluted, and/or varied in cross-sectional width. The one or more channels may lead to additional heat rejection benefits as the fluid contacts each row of battery cell cavities on an opposing side of the well plate from the battery cell. For instance, the varied cross-sectional width may reduce packaging sizes and/or force a higher average velocity of a fluid along the cavity walls.

In some embodiments, a pump is configured to direct the fluid through the one or more channels. A computing system may be configured to control a flow rate of the pump. Further, in some instances, a sensor can be operably coupled with the cooling system and configured to output data indicative of at least one of a fluid temperature, a fluid flow rate, or a fluid volume within the cooling system. Based on the data received from the sensor, the computing system may adjust a flow rate of the pump and/or instruct the pump to pull fluid from a reservoir that may be fluidly coupled with the cooling system.

Referring now to FIG. 1, in some embodiments, a battery module 10 can include a retainer assembly 12 having a well plate 14 that is operably coupled to a substrate 16. The well plate 14 may define one or more battery cell cavities 18 that are accessible along an exterior side 20 of the well plate 14. However, in other examples, the battery cell cavities 18 may be accessible through any other portion of the retainer assembly 12 without departing from the scope of the present disclosure. Accordingly, in some embodiments, the well plate 14, the substrate 16, and/or both the well plate 14 and the substrate 16 can define one or more of the battery cell cavities 18. Furthermore, in some embodiments, multiple retainer assemblies 12 may be coupled with one another to form a larger capacity retainer assembly 12. It will be appreciated that the multiple retainer assemblies 12 may be coupled through any practicable process without departing from the scope of the present disclosure. In addition, the retainer assemblies 12 may be orientated in any manner relative to one another to meet various design constraints without departing from the scope of the present disclosure.

In some embodiments, the one or more of battery cell cavities 18 can be positioned in an offset orientation. For example, as illustrated in FIG. 1, a first row 22 of battery cell cavities 18 may have central axes that align in a first direction (i.e., an X-axis direction or a longitudinal direction). An adjacent second row 24 of battery cell cavities 18 may also have central axes that align in the first direction. However, the central axes of each cavity 18 in the first row 22 are offset from the central axes of each cavity 18 in the second row 24 in a second, perpendicular direction (i.e., Y-axis direction or a latitudinal direction).

In various embodiments, a battery cell 26 can be retained within each respective battery cell cavity 18 in a predetermined orientation to form a battery module 10. The battery cells 26 may be cylindrical, or any other geometrical shape, and be configured as an array positioned within the retainer assembly 12.

In some embodiments, the cylindrical battery cell 26 may include a cylindrical battery can 28, and an electrode assembly accommodated in the battery can 28. The battery can 28 may be configured to stand vertically and, in several embodiments, can be formed with internal metal foils having a high electrical conductivity, which hold the active materials of the battery cell 26, and may be formed from aluminum, copper, or any other practicable material.

Further, the battery can 28 may include electrode terminals 30, 32 both formed proximate to one portion 34 of the battery can 28. However, in other examples, the electrode terminals 30, 32 may be positioned at both the upper and lower portions of the battery can 28, respectively, without departing from the scope of the present disclosure. An electrical insulation member may be coated on a side of the battery can 28. That is, since the battery can 28 is electrically connected to an electrode of the electrode assembly therein, the battery can 28 may be coated with, for example, an insulating film to surround the side of the battery can 28 in order to prevent an unintended conductive object from contacting the battery can 28 and thus causing an electric leakage.

In various examples, the electrode assembly may have a jelly-roll type structure where the electrode assembly is rolled with a separator being interposed between a positive electrode and a negative electrode. A positive electrode tab may be attached to the positive electrode and connected to the first electrode terminal 30 at the upper end portion of the battery can 28. A negative electrode tab may be attached to the negative electrode that is connected to the second electrode terminal 32 also located at the top end portion of the battery can 28.

During charging and/or discharging of each battery cell 26 within the retainer assembly 12, heat is generated due to an electrochemical reaction and/or ohmic losses. Thus, if the heat of the battery module 10 generated during the charging and discharging process is not effectively removed, heat accumulation may occur. Accordingly, the battery module 10 may also include a cooling system 38 that can be implemented within the retainer assembly 12 for cooling the battery cells 26 included therein. In addition to the cooling system 38, the substrate 16 may also define one or more fins 40 that may provide structural support for the module 10 and/or act as a heat sink to further reject heat from the battery module.

In various instances, a temperature gradient within each battery cell 26 can be the ultimate limiting factor for the thermal performance of the cooling system 38. For example, even if the outside of the battery cell 26 was connected to an infinitely conductive heat sink, the battery cell 26 would still develop radial and axial temperature gradients due to the finite conductivity of its construction. Therefore, it is important to note that the layered construction of the battery cell jelly roll gives rise to an anisotropic variation in thermal conductivities in the axial and radial direction. Radially, heat must cross thin foils of metal, polymer, and active material in series. Since the non-metallic components of this stack up have low thermal conductivity, the lumped radial thermal conductivity is quite low (e.g., k_{radial}=˜1-3). Axially, heat can conduct up the metal foils and non-metals in parallel and thus exhibits and a higher thermal conductivity (e.g., kₐₓᵢₐₗ=˜20-30). However, the anisotropic nature of the material is counteracted by the cylindrical geometry of the battery cell 26 where the critical length scale is the radius or the length which differ by a factor, wherein the factor, in some embodiments, may be the nominal length divided by the nominal radius, (e.g., for a 21700 battery cell—70 mm/10.5 mm=6.67).

The contributions of the axial and radial conduction can be summarized into an equivalent lumped thermal resistance. For example, if a battery cell 26 is entirely insulated except for the bottom surface and assuming the battery cell 26 generates heat evenly throughout the volume of the battery cell can, the heat flow may be generally modeled by Fourier's law of conduction such that a prediction of the development of a parabolic axial temperature distribution may be calculated. This expression may be simplified into an equivalent thermal resistance from top to bottom through equation (1) for axial thermal resistance in terms of peak temperature per watt of volumetric heat generation.

$${R}_{θ - a x i a l} = \frac{L}{2 π {K}_{a x i a l} {R}^{2}} \qquad ( 1 )$$

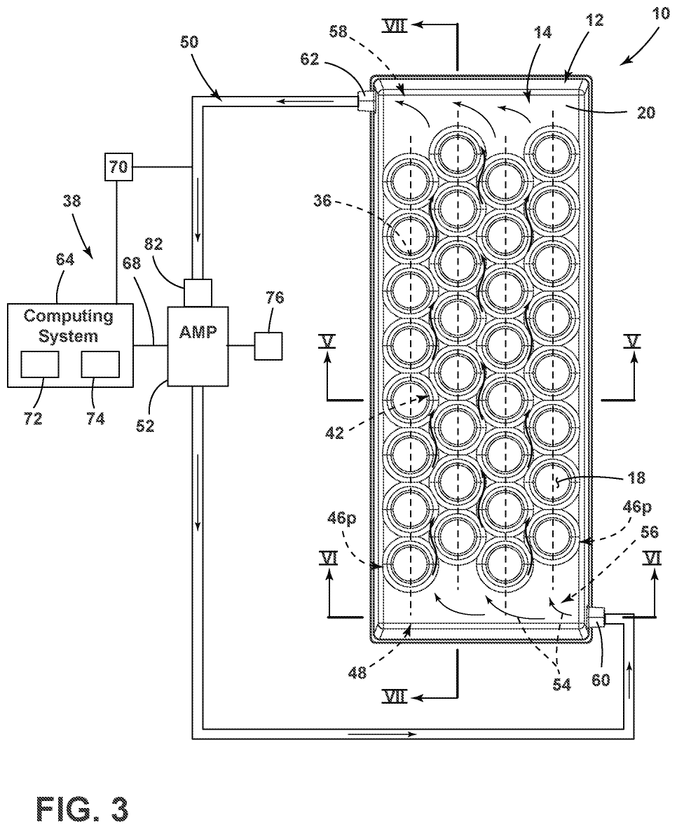

According to some embodiments, a 21700 cylindrical battery cell 26 may be utilized, which has a nominal length L=70 mm and R=10.5 mm. Given the above values of Kₐₓᵢₐₗ, the axial thermal resistance is ˜3.6-5 C/W, which may be considered low, but illustrates that all the heat will get out of the bottom. Further, a battery cell 26 bonded to an aluminum cold plate with a 1 mm thick insulator with k=1 w/mk (which may be typical for an adhesive 78 (FIG. 3) such as epoxy), the thermal resistance of the epoxy joint is approximately 2.9 C/W. If a fast moving liquid (h=1000) flows under the aluminum, and the conduction across the aluminum is ignored, the convection thermal resistance is about 2.9 C/W. In this idealized design, the resultant thermal resistance is around 9.4 to 10.8 C/W. The resistance can be decreased by reducing the thickness of the adhesive 78 and by using conductive compounds, but the battery cell 26 and convection resistances will still be high, and the electrical insulation is severely threatened.

For a battery cell 26 that is entirely insulated except for its cylindrical sides, which are exposed to an infinite heatsink and assuming a constant volumetric heat generation, the temperature profile may be illustrated as a radial parabola. In such situations, a single linear thermal resistance that predicts the peak temp per watt in C/W can be represented by the following equation:

$${R}_{θ - radi a l} = \frac{1}{4 π {K}_{r a d i a l} L} \qquad ( 2 )$$

For a 21700 cylindrical battery cell 26, the radial thermal resistance is 0.4-1.1 C/W, which may be considered a low thermal resistance. Furthermore, because of the larger surface area along the cylindrical sides of the battery can 28, the effect of an insulator and limited convection is greatly reduced. If the battery cell 26 was again glued into an aluminum tube with a 1 mm thick radial layer of adhesive 78 and cooled by a fast-flowing liquid (h=1000), the additional resistance of the adhesive 78 and convection would be 0.44 C/W in total. Due to the side conduction area being 13.3 times larger for a 21700 cylindrical battery cell 26 than the bottom area of a 21700 cylindrical battery cell 26, the side conduction area is 13.3 times less sensitive to a thickness of an insulator. Accordingly, side cooling of the battery cell 26 can be useful in achieving low thermal resistance in the presence of realistic insulator and convection limits.

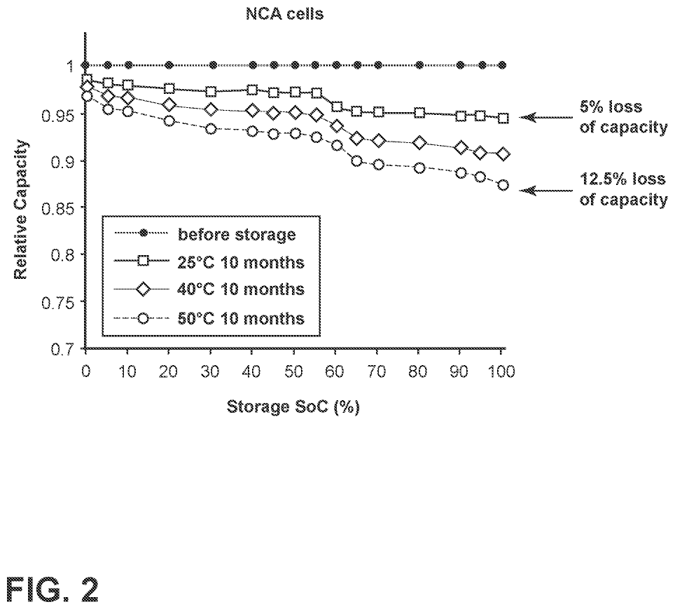

In some embodiments, by placing the axial and radial thermal resistance in parallel, a general performance of the cooling system 38 on the order of 0.5 to 1.1 C/W may be obtained as the key source of heat transfer is radially out of the battery cell 26, however, bottom cooling of the battery cell 26 can also assist in mitigating the heating issue. In other examples, the general performance of the cooling system 38 may be on the order of 0.2 to 3 C/W This result points towards a high-performance solution where the entire battery cell 26 is cooled except for the top which must be accessible for electrical connections (single side connections with negative connections to the rim of the battery cell 26). For instance, according to some examples, a power battery cell 26 operating at a C-rate (C) of 3-4 might dissipate 3-5 watts thermal and, therefore, may rise by 10 to 25 degrees Celsius (° C.) above inlet during discharge. In other examples, the power battery cell 26 operating at a C-rate (C) of 3-4 might dissipate 3-5 watts thermal and, therefore, may rise by 15-40 above inlet degrees Celsius (° C.) during discharge. Firstly, this level of power can be accessed continuously (or intermittently) without thermal limiting (e.g., guideline to keep battery cells below 60° C., reasonable inlet fluid temp is 25° C.). Secondly, the battery cells 26 can cool during extended utilization such that the temperature and the time components of battery cell lifetime degradation can be strongly reduced. As illustrated in the graph provided in FIG. 2, when battery cells 26 can be kept cool, the rate of degradation is significantly reduced. Therefore, being able to continuously operate battery cells 26 at a moderate temperature can further extend the usable lifetime of the battery cells 26, and, consequently, the battery module 10.

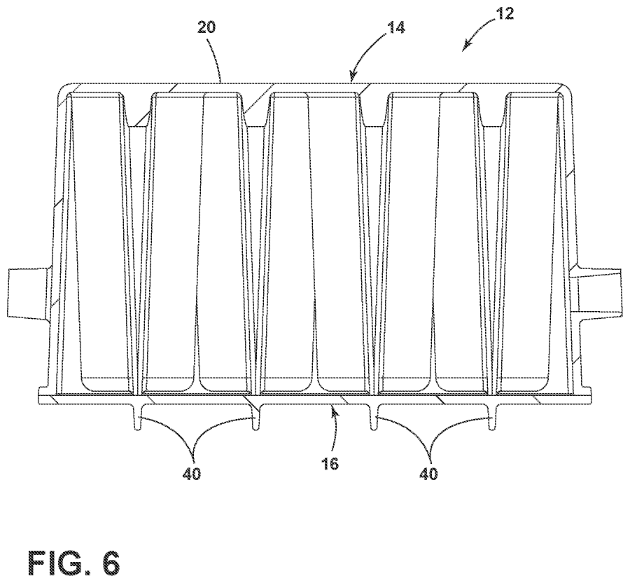

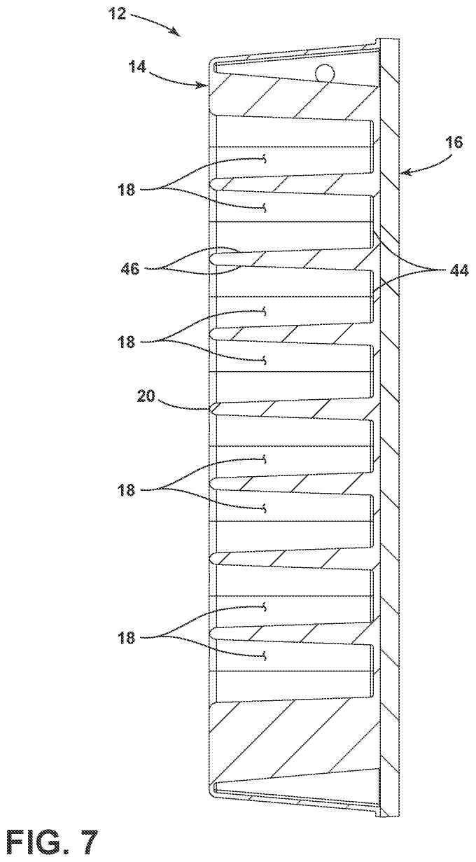

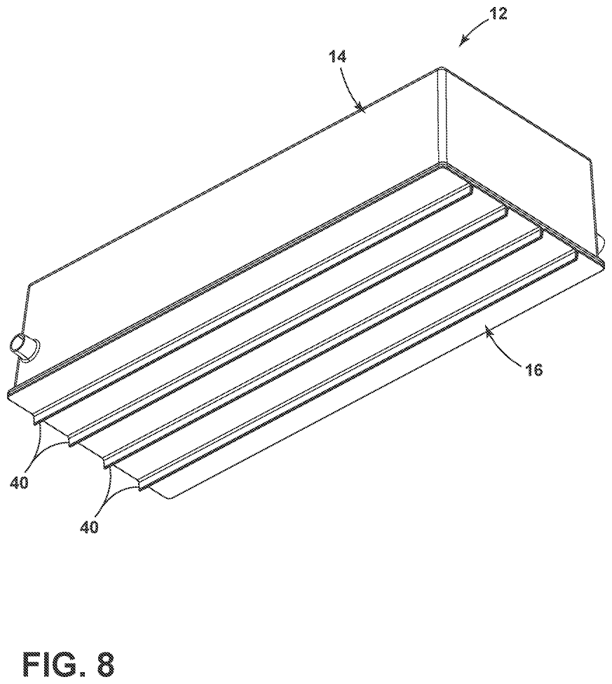

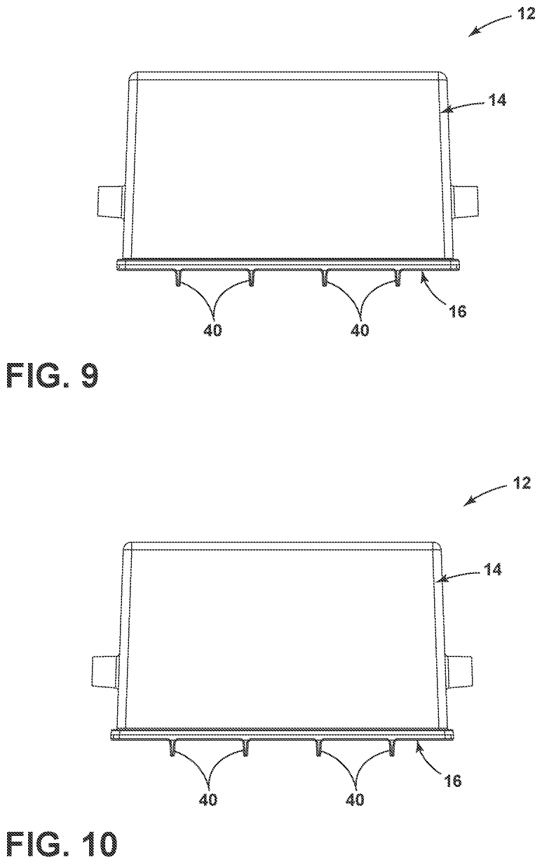

Referring to FIGS. 3-9, in some embodiments, the battery cell 26 is removably or permanently affixed within a respective battery cell cavity 18. For instance, the battery cell 26 may be retained with the battery cell cavity 18 through the use of an adhesive 78, such as epoxy. However, the battery cell 26 may be retained in the cavity 18 through any other practicable manner. For instance, a locking assembly may retain each battery cell 26 within its respective battery cell cavity 18, each battery cell 26 may be welded into the cavity 18, the well plate 14 may be integrally formed around the respective battery cells 26, etc.

In some examples, each of the battery cell cavities 18 is defined by a bottom wall 44 and a side wall 46 that can be integrally formed with the well plate 14. Each of the side walls 46 of the cavities 18 can include a draft for manufacturing with specific processes, such as injection molding. In other examples, the well plate 14 may define one or more holes and a structure having side walls 46 and a bottom wall 44 that define the cavity 18 may be attached to the well plate 14.

As provided herein, the battery cell 26 can be one of the fundamental limits to thermal resistance. However, the boundary conditions of the battery cell 26 (e.g., bottom versus side cooling) can determine the impact that other conduction and convection losses will have on the battery module 10. Accordingly, in some embodiments, a cooling system 38 is incorporated into the battery module 10 so that the battery module 10 may be capable of rejecting heat. For instance, the cooling system 38 may include one or more channels 42 that can be defined between the well plate 14 and the substrate 16. The one or more channels 42 may generally encompass the areas between the well plate 14 and the substrate 16 that are offset from the battery cell cavities 18. As provided above, each row of battery cell cavities 18 may be offset from the adjacent rows. Accordingly, the one or more channels 42 may include a plurality of curved sections around each of the battery cell cavities 18. As such, in some embodiments, a plurality of curved, or otherwise offset, sections can form a “Z” shaped flow pattern with the flow proceeding from the inlet 60 and exiting through the outlet 62 on opposite sides of the module 10. However, the channels may be formed in any other orientation that forms a practicable and/or desirable flow path.

With further reference to FIGS. 3-5, the well plate 14 and/or the substrate 16, may define one or more ribs 36 that extend between the well plate 14 and the substrate 16. The ribs 36 are configured to operably couple the well plate 14 to the substrate 16 such that a plurality of elongated channels 42 are formed. In embodiments in which the ribs 36 extend from the well plate 14, the ribs 36 may extend from a bottom portion of each of the battery cell cavities 18 to form the one or more channels 42. In embodiments in which the ribs 36 extend from the substrate 16, the ribs 36 may extend upwardly and operably couple with a bottom portion of each of the battery cell cavities 18 to form the one or more channels 42. In addition, perimeter channels 42p may be formed between an outer row of the battery cell cavities 18, the substrate 16, and a side wall 46 of the well plate 14.

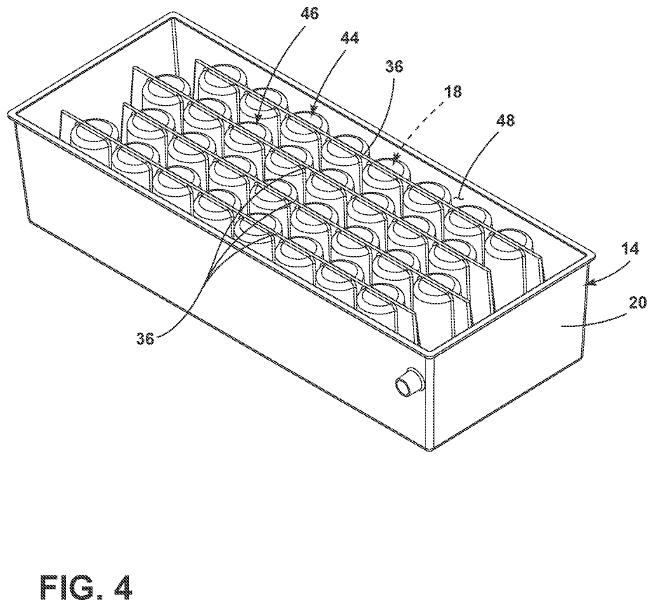

In some embodiments, such as the one illustrated in FIG. 4, the ribs 36 may internally divide the retainer assembly 12 into multiple parallel flow channels 42 by deep ribs 36 that link rows of battery cells 26. The ribs 36 can serve multiple functions. For instance, in some embodiments, the ribs 36 can seal off multiple flow channels 42 to form a parallel set of long channels 42 to prevent diagonal flows around the battery cells 26. As used herein, diagonal flow would be across the module 10 from the inlet 60 to the outlet 62 directly, which could starve the corners from fluid and/or create a non-uniform flow of fluid 54 within the module 10. The ribs 36 can terminate before the front and rear walls of the module to form an inlet and outlet duct 56, 58. The well plate 14 is fixed to the plurality of ribs 36 and a rim 66 (FIG. 1) of the substrate 16 through any practicable method. For example, an adhesive 78 (such as epoxy) may be positioned between the ribs 36 and/or a rim and the well plate 14 to bond the components to one another. In other examples, the components may be welded to one another.

In various embodiments, the connection from the well plate 14 to the substrate 16 prevents the battery cell cavities 18 from flexing against the diaphragm like well plate 14. These connections also allow an internal space 48 defined between the well plate 14 and the substrate 16 to be pressurized without ballooning outwards as each individual channel 42 becomes a small, sealed region which can react out internal pressure via tension down the rib. Furthermore, the ribs 36 help the global structure resist external loads by turning the structure into a large sandwich panel (the well plate 14 and the substrate 16 are held apart at a great distance to create a stiff and light structure). Finally, the ribs 36 between the battery cells 26 also extend barely below the battery cells 26 to form a set of parallel joints that are ideally suited for linear friction welding.

In some embodiments, the cooling system 38 can include a fluid circuit 50 and a pump 52 in fluid communication with the fluid circuit 50 to allow a fluid 54 to be directed through the one or more channels 42. The fluid 54 may be any substance, such as liquid or gas, that is used to reduce or regulate the temperature of a system. In various examples, the fluid 54 may have a high thermal capacity, a high thermal conductivity, a low viscosity, a low-cost, be non-toxic, chemically inert, and/or neither causes nor promotes corrosion of the cooling system 38. In some applications, the fluid 54 may also be an electrical insulator.

In operation, with the actuation of the pump 52, the one or more internal parallel flow channels 42 are fed by an inlet and outlet duct 56, 58 at each end portion of the module, which receive and exhaust the fluid 54 through the inlet and outlet ports 60, 62. These ducts 56, 58 are larger in cross-section than the fluid channels 42 and thus have a lower pressure drop than the fluid channels 42. The ducts 56, 58 and the “Z” shaped flow pattern of the fluid 54 through the one or more channels 42 are used to create an evenly distributed flow rate for all channels 42, thus minimizing lateral temperature gradients across the module that reduce the cooling effectiveness. The rim 66 (FIG. 1) of the module 10 can be a single continuous loop around the exterior of the module 10. The outer sealing border and the inlet/outlet ports 60, 62 can be the only interfaces where a leak would cause fluid 54 to exit the flow cavity and pose a risk to the battery module 10. Since some fluids 54 are electrically conductive, it can be critical that they are kept far away from the current-carrying elements of the battery. Since the sealed outer boundary is at the bottom of the module, a leak may need to deposit an amount of fluid 54 before the current-carrying battery cells 26 will be submerged. The presence of a single critical welded/sealed interface helps decrease the chance of leakage. In some instances, a seal may be placed proximate to the rim 66 (FIG. 1) to further prevent leakage from the module 10. In comparison, a conventional system with direct immersion of each battery cell 26 in an inert fluid 54 must individually seal to each battery cell 26 and thus has many points of failure.

With further reference to FIGS. 3-5, the cooling system 38 may also include a computing system 64 communicatively coupled to one or more components of the battery module 10 to allow the operation of such components to be electronically or automatically controlled by the computing system 64. For instance, the computing system 64 may be communicatively coupled to a pump 52 (e.g., via a communicative link 68) to control the operation thereof. Specifically, in several embodiments, the computing system 64 may be configured to regulate the pump operation such that the fluid 54 is output from the pump 52 as a suitable pressure so as to maintain the circuit pressure within the fluid circuit 50 within a desired or predetermined pressure range (e.g., an operator-selected or prescribed pressure range). For example, in some embodiments, the computing system 64 may be configured to receive pressure-related data from one or more sensors 70 fluidly coupled or otherwise provided in fluid communication with the fluid circuit 50. In such embodiments, the computing system 64 may be configured to monitor various variables of the circuit, such as a circuit pressure of the cooling system 38 based on the sensor feedback provided by the sensor 70 (the communicative links between the sensor 70 and the computing system 64 being omitted to simplify the illustration) and subsequently control the operation of the pump 52 to maintain the circuit pressure within the desired pressure range. Additionally, and/or alternatively, in some embodiments, the sensor 70 may be configured as a flow rate sensor and/or a temperature sensor.

In some embodiments, a heat exchanger 82 may be operably coupled with the fluid circuit 50. The heat exchanger 82 may be any type of device that is configured to transfer heat to and/or from the fluid circuit 50. For example, the heat exchanger may be configured as a shell and tube heat exchanger, a double pipe heat exchanger, a plate heat exchanger, a condenser, an evaporator, a boiler, a combination thereof, and/or any other device that can remove heat from the module 10 disclosed herein.

In general, the computing system 64 may comprise one or more processor-based devices, such as a given controller or computing device or any suitable combination of controllers or computing devices. Thus, in several embodiments, the computing system 64 may include one or more processor(s) 72, and associated memory device(s) 74 configured to perform a variety of computer-implemented functions. As used herein, the term “processor” refers not only to integrated circuits referred to in the art as being included in a computer, but also refers to a controller, a microcontroller, a microcomputer, a programmable logic circuit (PLC), an application specific integrated circuit, and other programmable circuits. Additionally, the memory device(s) 74 of the computing system 64 may generally comprise memory element(s) including, but not limited to, a computer readable medium (e.g., random access memory RAM)), a computer readable non-volatile medium (e.g., a flash memory), a floppy disk, a compact disk-read only memory (CD-ROM), a magneto-optical disk (MOD), a digital versatile disk (DVD) and/or other suitable memory elements. Such memory device(s) 74 may generally be configured to store suitable computer-readable instructions that, when implemented by the processor(s) 72, configure the computing system 64 to perform various computer-implemented functions, such as one or more aspects of the methods and algorithms that will be described herein. In addition, the computing system 64 may also include various other suitable components, such as a communications circuit or module, one or more input/output channels, a data/control bus and/or the like.

It should be appreciated that the various functions of the computing system 64 may be performed by a single processor-based device or may be distributed across any number of processor-based devices, in which instance such devices may be considered to form part of the computing system 64. For instance, the functions of the computing system 64 may be distributed across multiple application-specific controllers, such as a pump controller, a heat exchanger controller, and/or the like.

With further reference to FIGS. 3-5, the pump 52 may also be coupled to a fluid reservoir 76. The reservoir 76 may store additional fluid 54 that may be added to the pumped fluid 54 when the circuit is below a predefined threshold. Additionally, and/or alternatively, the fluid 54 may be circulated from the retainer assembly 12 to the reservoir 76 and back to the one or more channels 42 and/or the fluid circuit 50. Thus, by utilizing additional fluid 54, the temperature of the fluid 54 may be reduced as it enters the inlet of the retainer assembly 12.

In operation, heat from the battery cell 26 is conducted across the adhesive 78 and the side and bottom walls 44, 46 of the cavity 18 (axially and radially) before being carried into the flowing fluid 54 via forced convection. In some embodiments, the battery cell cavities 18 can each be cylindrical with no draft and include a side wall 46 that may be less than 2 mm thick, less than 1.5 mm thick, less than 1 mm thick, or less than 0.5 mm thick. In other embodiments, the wall thickness of the cavity walls within the well plate 14 can be about 2 mm in thickness and have a draft of 1-2 degrees for ease of machining. In some instances, as the wall thickness increases, the injection pressure required to fill an injection mold cavity reduces and thus enables the use of smaller machines with a lower tonnage. For example, the graph of FIG. 10 illustrates the sensitivity of the design to changes in wall thickness at 1 degree of draft. In some examples, the thickness of the cavity walls can be tripled (e.g., from 1 mm to 3 mm) while the thermal resistance of the system only increases by about 58%. However, increasing the wall thickness causes the battery cell packing fraction to decrease as the battery cell pitch grows larger.

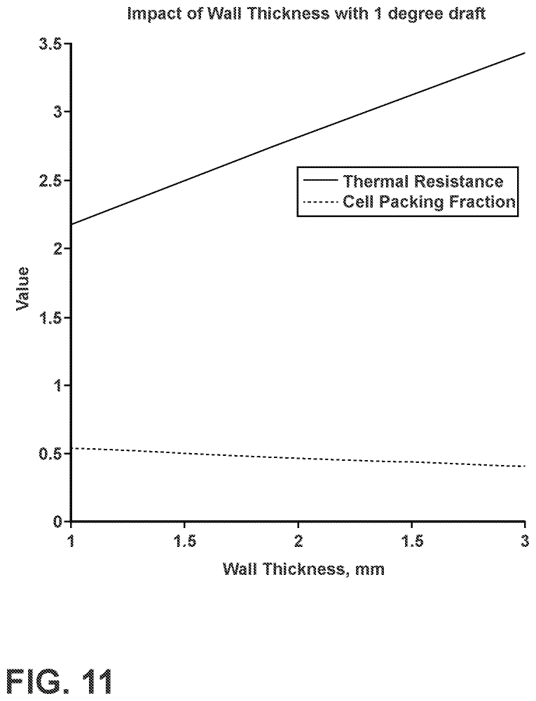

In addition, increasing a draft angle may make manufacturability easier, but comes with a cost in thermal performance and battery cell 26 to battery cell spacing pitch. For example, the graph of FIG. 11 shows the sensitivity of a 1 mm reference design to changes in draft angle. As the draft angle grows larger, the thermal resistance increases due to the increased conduction length of the adhesive 78 (e.g., epoxy), as well as the reduction in the convection coefficient of the fluid flow. As the draft angle increases, the fluid flow channel grows wider, reducing both the Nusselt number (which is higher for high aspect ratio rectangular channels) as well as increasing the hydraulic diameter. Both of these factors combine to reduce the convective heat transfer coefficient h, as the draft angle increases. Furthermore, large draft angles, such as angles that are about or greater than 5 degrees, result in large battery cell-to-battery cell pitch spacing which quickly reduces the area packing factor of battery cells 26, forcing the battery module 10 to grow in size and, therefore, cost. Accordingly, in some examples, the well plate 14 may have a draft angle between 0.5 degrees and 2.5 degrees for each battery cell cavity 18 to accommodate for manufacturability and thermal/packing performance when the well plate 14 is manufactured through an injection molding process. In addition, any voids, defects, cracks, or weld lines within the plastic could allow water intrusion and reduce the electrical resistance of the assembly. By having a battery cell wall thickness between 0.5 degrees and 2.5 degrees (e.g., a thickness of 0.5 mm, 1 mm, 1.5 mm, 2 mm, 2.5 mm, and/or any other value within the state range) can decrease the chance that a small manufacturing defect can cause an electrical isolation failure. For instance, in one non-limiting example, an expected thermal resistance for a well plate 14 that includes a 2 mm battery cell cavity wall thickness within the battery cell cavities 18, a 2-degree draft is illustrated in Table 1. In some instances, a shift from a more difficult to manufacture 1 mm cavity wall thickness, 1 degree of draft well plate 14 to a 2 mm cavity wall thickness, 2 degrees of draft well plate 14 may only increase the thermal resistance by 37%.

TABLE 1

| | Axial resistance | Radial resistance |
|---|---|---|
| Part - heat transfer method | C/W | C/W |
| Cell - conduction | 4.94 | 1.16 |
| Epoxy - conduction | 1.64 | 0.34 |
| Plastic - conduction | 21.90 | 1.14 |
| Fluid - convection (h = 475) | 6.92 | 0.37 |
| Total | 22.31 | 3.02 |
| Total resistance = 2.97 C/W | | |

With further reference to FIGS. 3-5, a fluid selection may alter the efficiency of the cooling system 38. Currently, many batteries are air cooled for cost, simplicity, and electrical isolation concerns. Unfortunately, the general weakness of air cooling is the low density of air. While the specific heat capacity (c) of air (Cp˜1,000 J/kg-k at STP) is lower than oil or water (mineral oil=1,670, water=4,186), its low density (˜1.2 kg/m³ at STP) means that in order to get enough thermal capacity (mc) through the battery to remove heat, a large volumetric flow rate may be required. This, in turn, forces high air velocities which require powerful fans. The end result can be a more inefficient system that includes large, power hungry blowers to achieve the high air-flow rates.

Another option as a fluid 54 is a dielectric oil. For example, cheaper mineral oils can be used for cooling as they have moderate densities and heat capacities. However, the high viscosity of oil (and its large variation with temperature) results in increased pumping power (though not as bad as fans). Furthermore, chemical compatibility and flammability can be concerns when working with oils. High performance heat transfer fluids 54 such as Novec and Flourinert have low viscosities and are very chemically inert, but these properties come at increased costs.

Therefore, in some embodiments, the cooling fluid 54 may be any material that has a high density and a high heat capacity. For example, in some examples, water-glycol antifreeze mixtures may be used as these mixtures can provide a good balance of properties at a low cost. Due to the usage of water-glycol antifreeze mixtures, in some implementations, the cooling system 38 may be formed from a polymeric material that is resistant to various mixtures, such as water-glycol antifreeze mixtures. For instance, the well plate 14 may be formed from a Polyphenylene Sulphide (PPS) resin because of its extreme chemical resistance to antifreeze. Furthermore, the PPS cell cavity wall forms a robust electrically isolating barrier between the battery cell 26 and cooling fluid 54. The combination of water-glycol and PPS allows for the safe use of a high performance and cheap fluid.

In various embodiments, the cooling fluid 54 may be able to support a low convection resistance from the outside of the battery cell cavity 18 as well as absorb substantial amounts of heat without a large increase in temperature. When the battery module 10 operates and the battery cells 26 dissipate thermal power, that power will be absorbed into the fluid 54. If the fluid thermal mass-flow rate is too low, then a large temperature difference will be created from the inlet to the outlet of each module. This temperature gradient caused by the fluid flow will result in different aging and electrical performance of the battery cells 26. The flow rate to meet a given temperature delta can be calculated through equation (3), where P is the thermal power dissipated in watts, c is the specific heat capacity of the fluid in j/kg-k and delta-T is the increase in fluid temperature.

$$\dot{m} = \frac{P}{c Δ T} \qquad ( 3 )$$

According to one non-limiting example, assuming a worst-case scenario power dissipation of 5 watts per battery cell, and 288 battery cells per module, a total power dissipation of 1440 w would be achieved. Assuming a 50-50 (by weight) water-ethylene glycol blend (Dowtherm SR-1 at 25° C. nominal temperature), the heat capacity is 3,303 j/kg-k, and thus requires a mass flow rate of 0.145 kg/sec per module. Given the density at the same conditions is 1,072 kg/m³, a volume flow rate of 0.136 liters/second per module may be required. To supply a pack of supply eight modules with this same flow rate requires the pump 52 to operate at a total flow rate of 16.9 gallons per minute for the pack. It will be appreciated that this is one non-limiting example for illustrative purposes. Accordingly, any of the values discussed herein may be altered without departing from the scope of the present disclosure.

In some examples, the retainer assembly 12 can define flow channels 42 in the module, each with a cross-sectional area of 2.71e⁻⁴ m². In addition, the average velocity in each channel 42 can be about 28 millimeters per second (mm/s), which is relatively slow. Assuming a channel 42 defined by a 2 millimeters (mm) thick cavity wall and a 2-degree draft angle, the predicted hydraulic diameter can be about 5.5 mm. Using the dynamic viscosity of the fluid (3.88 mPa-S), the Reynolds number for this internal pipe flow can be about 42.2, which is well within the laminar regime and very far from the critical transition region around RE=2,300-2,700. Since the channel 42 has laminar flow with a constant heat flux boundary condition from the battery cells 26, established Nusselt number correlations can be used. A circular channel 42 with the fully developed flow (hydrodynamically and thermally) has a Nusselt number of 4.36. A rectangular channel 42 with an aspect ratio of 3:1 has the same Nusselt number and even higher aspect ratios achieve higher Nusselt numbers (closer to 6). For the non-limiting example provided herein, a value of 4.36 can be assumed. With a fluid conductivity of 0.38 w/mk, the heat transfer coefficient h can be found by the equation below:

$$h = \frac{N {u}_{d h} k}{{D}_{h}} \qquad ( 4 )$$

In order to achieve high heat transfer coefficients with laminar flow, a generally thin high aspect ratio channel 42 with a small hydraulic diameter may be implemented. The heat transfer coefficient is higher when the draft angle is lower because the flow cavity has a higher aspect ratio. The above value for the Nusselt number is true for a fully developed flow and may be higher for regions of the flow that are not fully developed hydrodynamically and thermally. For instance, in the non-limiting example provided herein, the flow channels are 571 mm long, the fluid entrance length is 12 mm (hydrodynamically fully developed), but the thermal entrance length is 334 mm (thermally fully developed). This means that the channel 42 will actually see a higher average Nusselt number because of the unsteady thermal distribution in the fluid 54. It will be appreciated that this is one non-limiting example for illustrative purposes. Accordingly, any of the values discussed herein may be altered without departing from the scope of the present disclosure.

With further reference to FIGS. 3-5, in some embodiments, the flow channels 42 can also have a very low pressure drop because of the low fluid velocity. For instance, using Darcy's Law for pipe flow, the pressure head developed across the flow channels 42 can be approximately 65 Pa, which is generally low. This means that the pumping power required to move the fluid 54 in the battery module 10 may be around only 10 milliwatts. Furthermore, the low-pressure drop applies a smaller structural load to the enclosed battery module 10. The low stresses of this flow system help enable the use of plastics. For example, if direct refrigerant cooling were used, the pressure in the module could be on the order of 1 MPa to keep the fluid 54 at the proper saturation temperature.

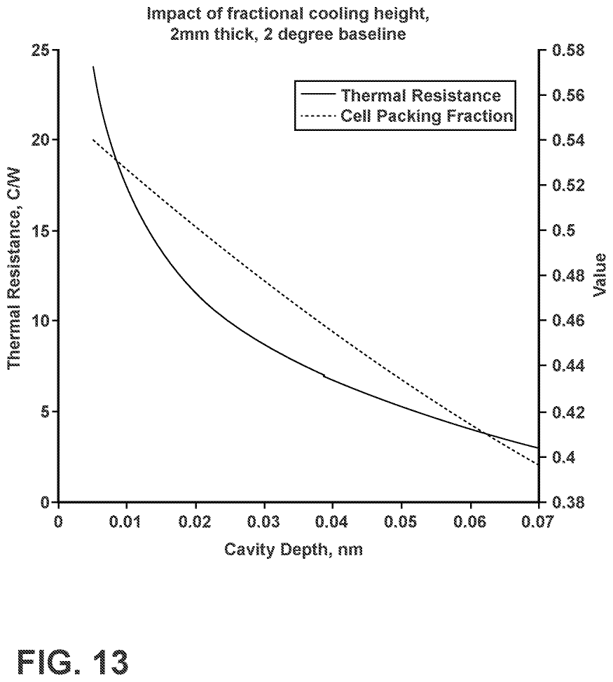

There are many factors that go into the improved performance of the cooling system 38 provided herein over simple bottom cooling. For example, the performance of complete cooling is much greater than that of a bottom cooling system that slightly extended up the sides of the battery cell 26. While cooling the bottom face of the battery cell 26 and a small portion (e.g., 0-3 mm of the side walls 46 of the cavities 18) of the sides would increase the conduction area, it is less efficient than a full height cooling system 38. The thermal performance of the cooling system 38 can be sensitive to the height of the molded body. For example, even decreasing the cavity depth by a small portion can drastically increase the thermal resistance of the network. This sensitivity is driven by multiple variables. For example, as the cavity height is reduced, the heat must conduct axially up the exposed portion of the battery cell 26 that extends beyond the cooled region. Furthermore, as the cavity depth is decreased, the area of cooling falls linearly, causing the conduction and convection resistances to rise hyperbolically. The graph provided in FIG. 13 shows the sensitivity of the thermal resistance network to the “cooled height” of the battery cell 26. As illustrated, dropping the cooled height by 10 mm can increase the resistance by 33%, while dropping the height by 25 mm can double the resistance.

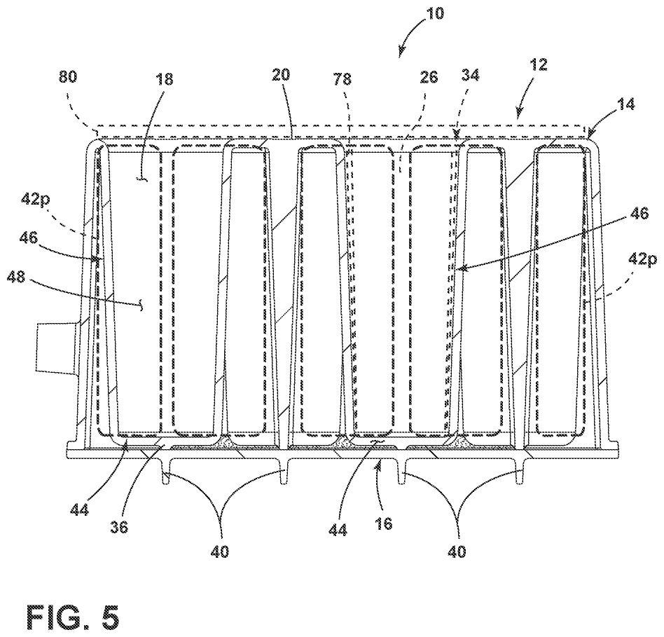

The effectiveness of complete cooling can be dependent on fully cooling a majority of the height of the battery cell 26. Increasing the thickness or draft angle of the molded cavity 18 may be preferred to be reducing the height or depth of the cavity 18, even though a shorter cavity 18 would be much simpler and cheaper to mold. The majority or full height cooling concept also places the top of the molded part level with the top of the battery cell 26, allowing for busbars 80 (FIG. 5) and other parts to be affixed to the structure, possibly directly to the structure. Furthermore, covering the sides of the battery cells 26 can prevent conductive debris from shorting adjacent battery cells 26. Thus, covering the battery cells 26 and having a protective rim that extends up and around the battery cell top portions creates a passive safety system that makes it more difficult for a piece of metal debris to fall onto exposed battery cells 26 and short them out.

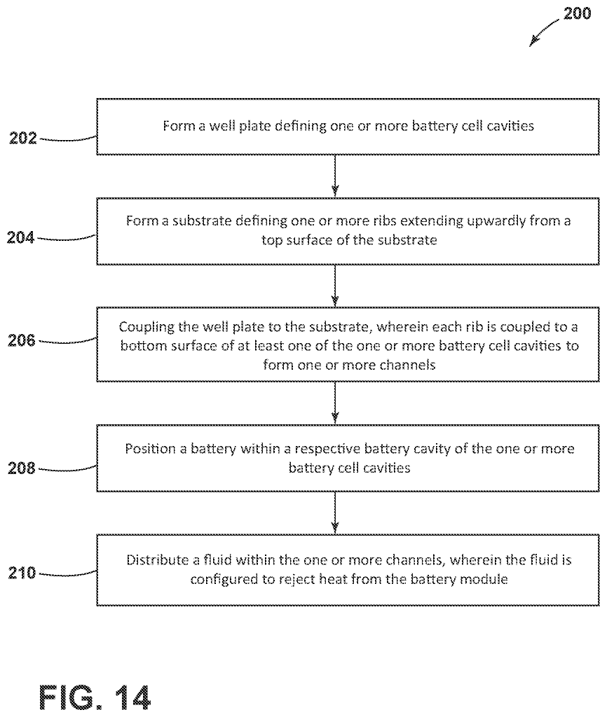

Referring now to FIG. 14, a flow diagram of a method 200 for manufacturing the battery module 10 is illustrated in accordance with aspects of the present subject matter. In general, the method 200 will be described herein with reference to the battery module 10 shown in FIGS. 3-9, as well as the various system components shown in these figures. However, it should be appreciated that the disclosed method 200 may be implemented with battery modules 10 having any other suitable configuration and/or within systems having any other suitable system configuration. In addition, although FIG. 14 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown, at step (202), the method 200 includes forming a well plate defining one or more battery cell cavities. In various embodiments, the well plate 14 may be formed from a PPS material. In some embodiments, the complex features that are specified by an approximately constant wall thickness spread over a surface may be created through the injection molding process. Furthermore, many engineering resins, including PPS, are only available in injection molded pellet form. It is very difficult to source extrusions, billets, or other shapes of PPS (excluding the thin sheets designed for thermoforming) and thus injection molding can be the method 200 by which this material is used.

While injection molding the well plate 14, other value-add manufacturing steps, such as insert molding aluminum conductors straight into the top of the well plate 14 or creating mounting points for additional hardware may be added. The injection molded well plate 14 can have additional features such as kinematic bumps to locate the plane of the battery cell 26 as well as ridges to help locate the battery cell 26 in an X-Y plane. The ability to insert mold PPS over aluminum conductors allows for the elimination of manufacturing processes, consumables such as adhesives 78, and the danger of having loose metal hardware above battery cells 26. Even if insert molding cannot be used, then the PPS can be heat staked to secure the aluminum conductors, still eliminating the need for adhesives, tapes, or other mounting hardware. The ability to cover up the metallic conductors improves safety particularly in the case where the module is used in a high voltage system and arcs could be formed during over current events.

At step (204), the method 200 includes forming a substrate defining one or more ribs extending upwardly from a top surface of the substrate. In some examples, the substrate 16 may be formed from a common material as the well plate 14. However, in other examples, the substrate 16 may be formed from a second material. For example, the first material may be a carbon-black filled polycarbonate and the second material may be an unfilled polycarbonate material.

At step (206), the method 200 includes coupling the well plate to the substrate, wherein each rib is coupled to a bottom surface of at least one of the one or more battery cell cavities to form one or more channels. This joint can be made economically but also at high strength over a large number of parallel features. Furthermore, this joint is buried inside the enclosed part and is not accessible to an external bonding operation. For example, in some embodiments, a linear friction welding process can offer a good solution for joining the two components because the frictional process generates heat directly at the interface and does not require heat to conduct across a barrier to reach the joint being created. Because the heat generated is generated by frictional forces and shear, as the material is melted it is extruded from the joint to expose more unmelted material. The extrusion of previously oxidized or contaminated material from the melt zone provides a strong weld while the shearing action displaces melted plastic resulting in a constant temperature boundary condition rather than a constant power boundary condition. This small nuance helps keep the maximum temperature just barely over the melting point of the material, thus minimizing degradation of the resin at high temperature. In other embodiments, the well plate 14 may be joined to the substrate 16 through other practicable methods, such as through a transmission laser welding process.

Linear friction welding requires rubbing the parts along a single linear axis. Since all of the parallel flow channels 42 have aligned structural ribs 36, this technology can join the majority of the module 10. To join the side walls 46 of the well plate 14 to the substrate 16, the side walls 46 can be reinforced to handle the bending loads forced by the friction welding process. In some instances, the side walls 46 can be internally reinforced and slightly “serrated” to create a sheet with a higher bending moment to resist these forces. Linear friction welding also creates some flash at the joint which can create debris in the flow channels 42. This debris can be trapped by features that surround the weld zone or cleaned out afterward.

At step (208), the method 200 can include positioning a battery cell 26 within one or more respective battery cell cavities 18. As provided herein, each battery cell 26 may be retained within the cavities 18 through an adhesive 78, mechanically retained, and/or integrally formed with the battery cell cavities 18.

Lastly, at step (210), the method 200 can include distributing a fluid 54 within the one or more channels 42, wherein the fluid 54 is configured to reject heat from the battery module 10. As provided herein the fluid 54, when flowing through the one or more channels 42, may reject heat from the battery module 10. In some embodiments, the one or more channels 42 may be defined between the interior surface of the well plate 14 to an interior surface of the substrate 16, which generally spans a substantial portion or majority (greater than half of the height) of the height of the battery cell 26.

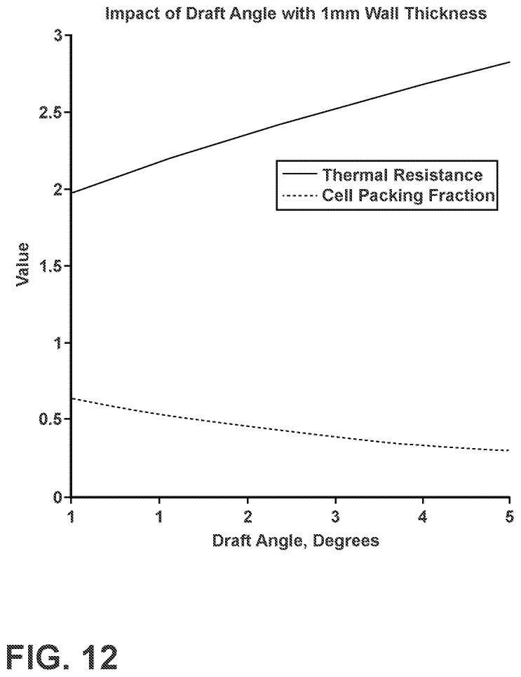

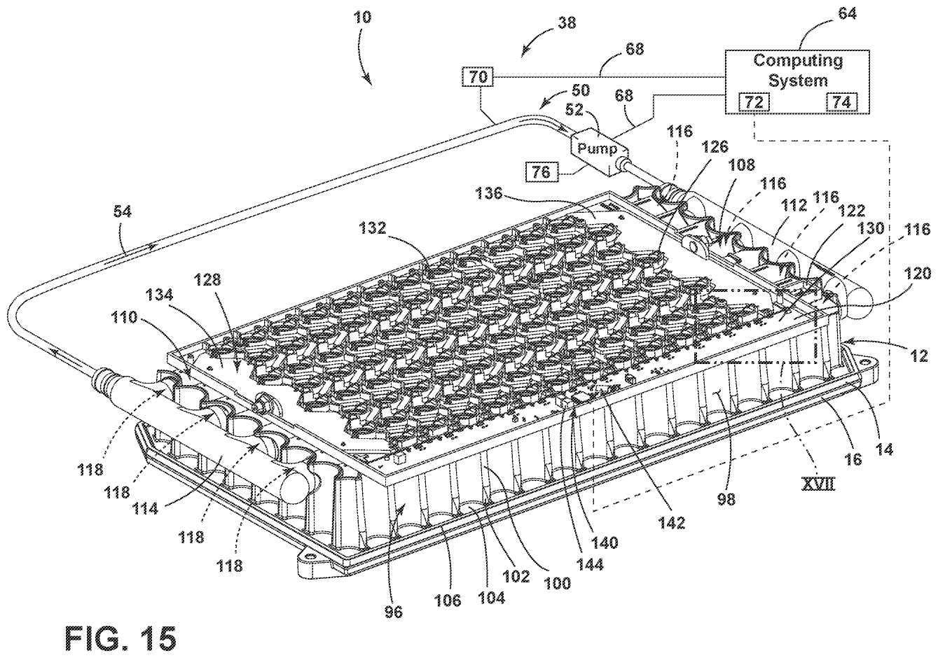

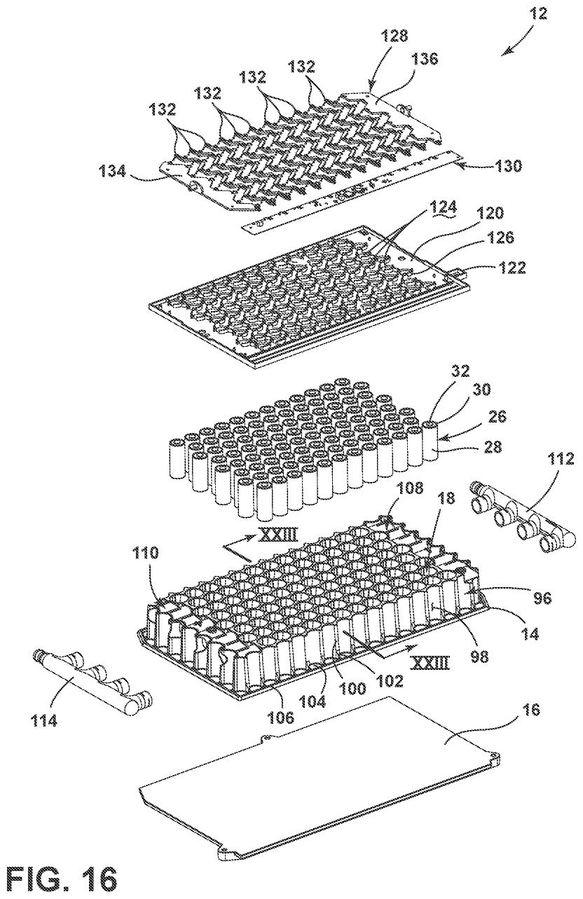

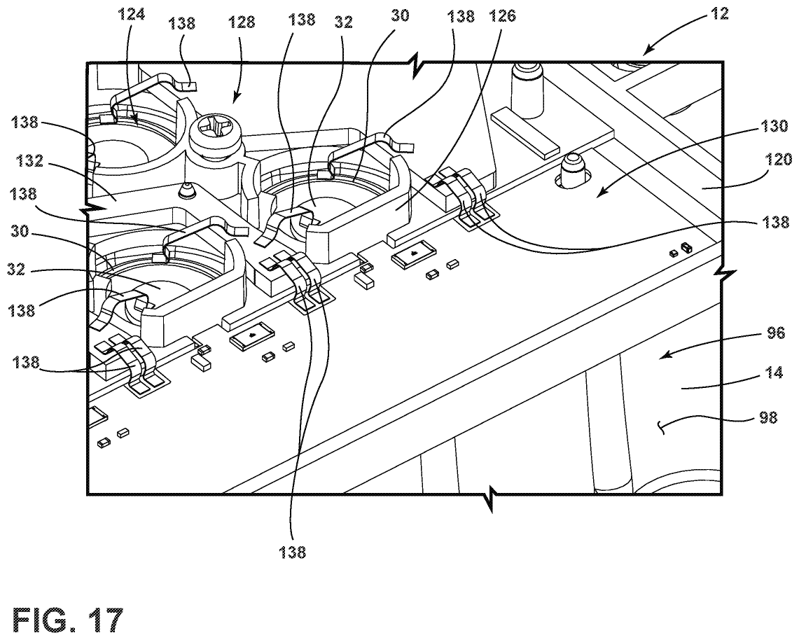

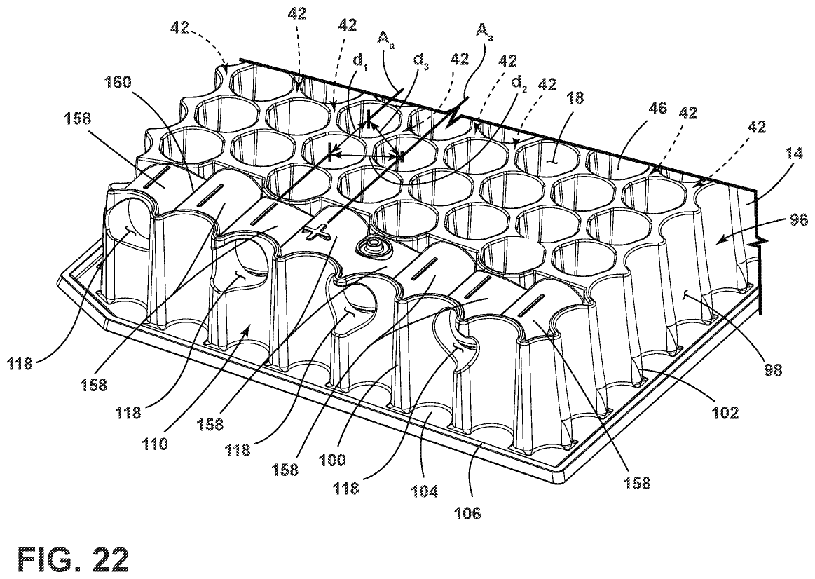

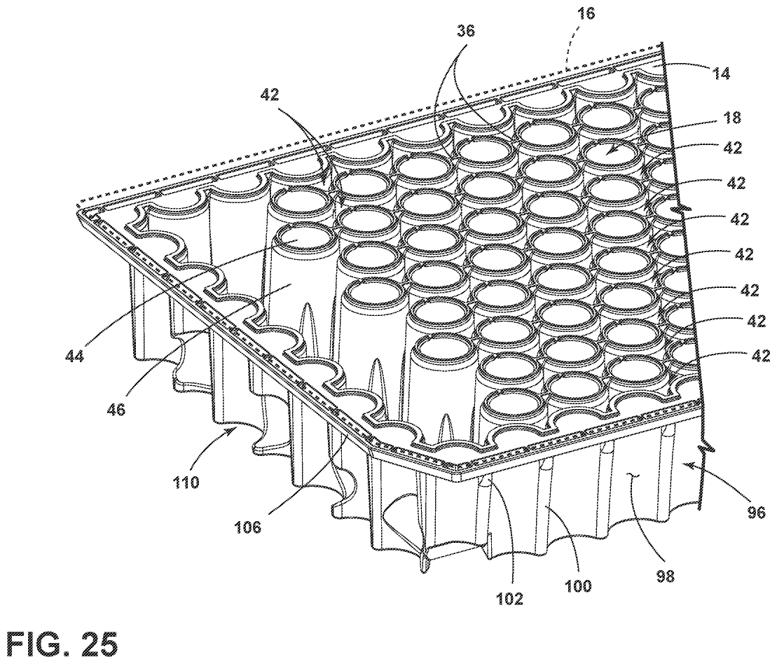

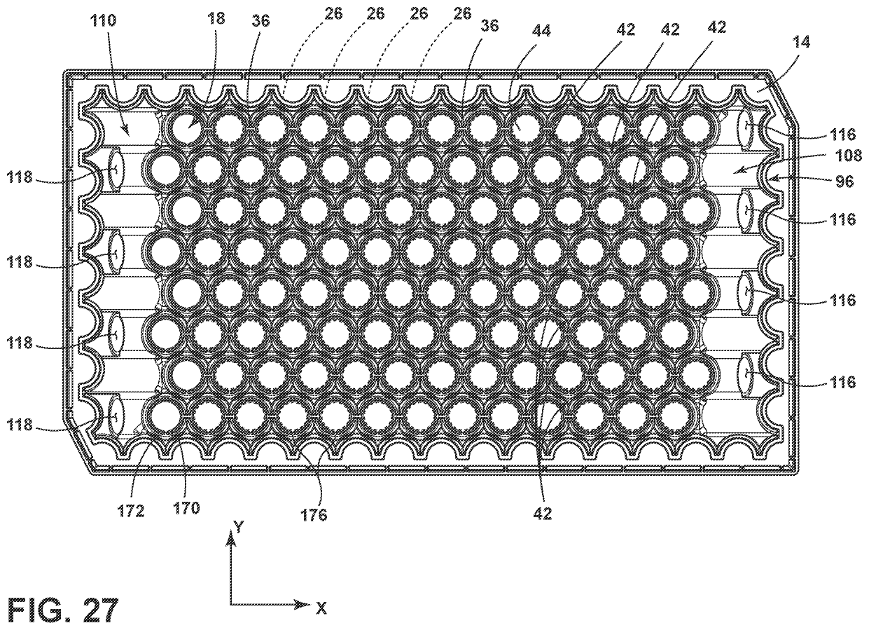

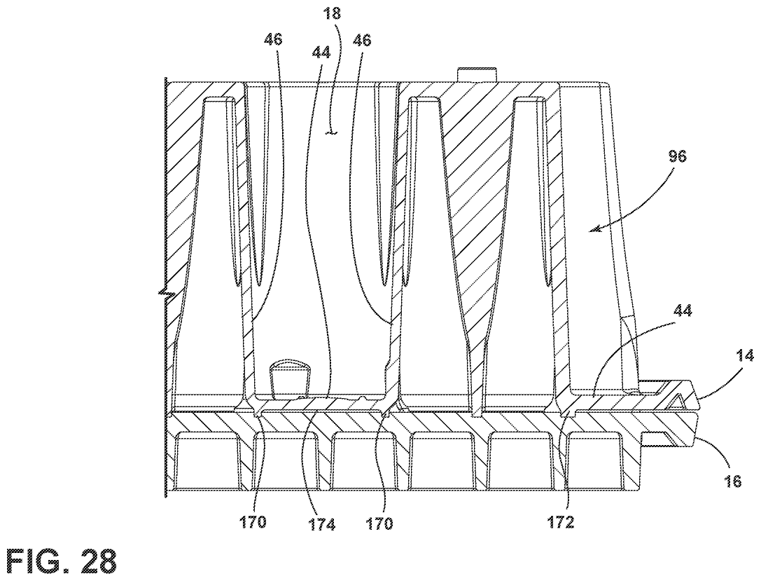

Referring now to FIGS. 15-28, views of a battery module 10 in accordance with various aspects of the present disclosure are provided. In certain exemplary embodiments, the battery module 10 may have various components that are configured in a generally common manner with the exemplary battery module 10 described above with reference to FIGS. 1-14. Accordingly, the same or similar numbers may refer to the same or similar parts and any features described with reference to FIGS. 1-14 may be included in the embodiments of FIGS. 15-28 without departing from the scope of the present disclosure.

In some embodiments, such as those illustrated in FIGS. 15-17, the retainer assembly 12 includes a well plate 14 operably coupled with a substrate 16. The well plate 14 may define one or more battery cell cavities 18 that are accessible along an exterior side 20 of the well plate 14. However, in other examples, the battery cell cavities 18 may be accessible through any other portion of the retainer assembly 12 without departing from the scope of the present disclosure. Accordingly, in some embodiments, the well plate 14, the substrate 16, and/or both the well plate 14 and the substrate 16 can define the battery cell cavities 18. Furthermore, in some embodiments, multiple retainer assemblies 12 may be coupled with one another to form a larger capacity retainer assembly 12. It will be appreciated that the multiple retainer assemblies 12 may be coupled through any practicable process without departing from the scope of the present disclosure. In addition, the retainer assemblies 12 may be orientated in any manner relative to one another to meet various design constraints without departing from the scope of the present disclosure.

Once the well plate 14 is coupled with the substrate 16, one or more channels 42 can be defined between an interior side of the well plate 14 and an upper side of the substrate 16. The one or more channels 42 may generally encompass the areas between the well plate 14 and the substrate 16 that are offset from the battery cell cavities 18. As provided above, each row (e.g., 22, 24) of battery cell cavities 18 may be offset from the adjacent rows (e.g., 22, 24). Accordingly, the one or more channels 42 may include a plurality of curved sections around each of the battery cell cavities 18. As such, in some embodiments, a plurality of curved, or otherwise offset, sections can define a flow pattern with the flow proceeding from an inlet plenum 108 and exiting through an outlet plenum 110 on opposite sides of the retainer assembly 12. However, the channels 42 may be formed in any other orientation that forms a practicable and/or desirable flow path.

The well plate 14 may define an outer wall 96 that surrounds the battery cell cavities 18. In various examples, the outer wall 96 may be non-planar in shape. For example, in various examples, the non-planar outer wall 96 can define one or more coves 98, which may be generally semi-cylindrical in shape. However, it will be understood that the coves 98 may be of any other non-planar shape. Moreover, it will also be understood that each cove 98 may be unique in shape and/or common with any of the remaining coves 98. In some instances, the coves 98 may be offset from an adjacent row of battery cell cavities 18 extending in a generally linear direction along the X-axis direction.

In various embodiments, adjacent coves 98 may be separated by a support structure 100. The support structure 100 may have a common width and/or a varied width there along in any of the X-axis direction, the Y-axis direction, and/or the Z-axis direction. Moreover, each support structure 100 may include a chamfered portion 102 that extends from the support structure 100 to a base portion 104.

A lip portion 106 may extend about a perimeter of the base portion 104. Further, in various embodiments, the lip portion 106 may be drafted to a defined draft angle, which may be between 15-70 degrees, 25-60 degrees, 40-50 degrees, and/or any other range, to allow for friction weld tooling to capture the outer perimeter of the well plate 14 to account for warping and/or deflection of the well plate 14 to allow for robust manufacturing. For example, the drafted lip portion 106 may allow a weld tool to slide against the rim to pull the warped lip portion 106 outwards in instances in which the lip portion 106 is warped.

With further reference to FIGS. 15-17, in various examples, the well plate 14 further defines an inlet plenum 108. The inlet plenum 108 may direct a fluid 54 into the one or more channels 42 and/or operably couple with a first manifold 112 that directs the fluid 54 into the retainer assembly 12. In some examples, the inlet plenum 108 may include one or more openings 116, which may extend through one or more coves 98 of the outer wall 96. In some instances, a surrounding boundary of the one or more openings 116 may be varied based on the openings 116 extending through various portions of the coves 98. In several examples, the well plate 14 also defines an outlet plenum 110. The outlet plenum 110 may receive the fluid 54 from the one or more channels 42 and/or operably couple with a second manifold 114 that receives the fluid 54 from the retainer assembly 12. In some examples, the outlet plenum 110 may include one or more outlet openings 118, which may extend through one or more coves 98 of the outer wall 96 on an opposing side of the battery cell cavities 18 from the outlet opening 118. In some instances, a surrounding boundary of the one or more openings 118 may be varied based on the openings 118 extending through various portions of the coves 98.

Referring still to FIGS. 15-17, as described herein, one or more battery cells 26 may be positioned within some or all of the one or more battery cell cavities 18. In various embodiments, the battery cell 26 can be retained within respective battery cell cavities 18 in a predetermined orientation to form a battery module 10. In some embodiments, the battery cell 26 is removably or permanently affixed within a respective battery cell cavity 18. For instance, the battery cell 26 may be retained with the battery cell cavity 18 through the use of an adhesive, such as epoxy. However, the battery cell 26 may be retained in the cavity 18 through any other practicable manner. For instance, a locking assembly may retain each battery cell 26 within its respective battery cell cavity 18, each battery cell 26 may be welded into the cavity 18, the well plate 14 may be integrally formed around the respective battery cells 26, etc.

Further, the battery can 28 may include electrode terminals 30, 32. In various examples, the electrode assembly may have a jelly-roll type structure where the electrode assembly is rolled with a separator being interposed between a positive electrode and a negative electrode. A positive electrode tab may be attached to the positive electrode and connected to the first electrode terminal 30 at the upper end portion of the battery can 28. A negative electrode tab may be attached to the negative electrode that is connected to the second electrode terminal 32 also located at the top end portion of the battery can 28.

Referring still to FIGS. 15-17, a panel 120 may be positioned above the well plate 14. In various instances, the panel 120 may be formed from an electrically and/or thermally insulative material. For example, in various embodiments, the panel 120 may be formed from a polymeric material, an elastomeric material, an insulative metallic material, ceramic materials, composite materials, and/or any other practicable material. In some instances, the panel 120 may include an extension 122 that accepts an alignment pin to ensure alignment of the panel 120 to the well plate 14. For example, the extension 122 may be offset from a center axis of the panel 120 and/or the well plate 14 to create a poka-yoke design. The panel 120 may include various other locators to further align the panel 120 and/or to maintain the panel 120 in a predefined location relative to the well plate 14.

The panel 120 defines one or more voids 124 that generally align with the battery cell cavities 18 of the well plate 14. In various examples, a brim 126 may extend about at least a portion of the one or more voids 124 of the panel 120. The brim 126 may have a varied height about the boundary thereof.

In various examples, a bus bar 128 and a circuit board 130 can be supported by the panel 120. The bus bar 128 employs a configuration that networks the one or more battery cells 26 together by connecting each battery cell 26 in series, in parallel, and/or both to the neighboring battery cells 26. First and second current collectors 134, 136 serve to carry the current from the battery cells 26 to the external loads of the battery. One or more conductors 132 that are parallel to the current collectors 134, 136 are referred to as “equalizing lines” because they force cells between two adjacent lines to be at the same voltage. If the voltage of any cell becomes different from the rest in this group during charge or discharge of a battery, the voltage difference will cause a current flow on the equalizing lines until the voltages are equalized. When all the cells employed in the battery are equalized, very little current will flow in the equalizing lines.

With reference to FIGS. 15-17, the one or more conductors 132 are positioned between each longitudinal group of batteries between the current collectors 134, 136. Each conductor 132 includes one or more tabs 138 extending from the conductor 132 with each tab 138 electrically contacting a terminal of an upstream battery cell 26 and/or downstream battery cell 26. The tabs 138 are configured to electrically couple with the terminals of the battery cells 26. The conductors 132 may also include tabs 138 that electrically couple with the circuit board 130. In such instances, the conductors 132 may be connected in series through the circuit board 130.

The circuit board 130 may constitute a battery management system (BMS) 140. The BMS 140 of each retainer assembly 12 may work together with the computing system 64 of the battery module 10. The BMS 140 may monitor the voltages and temperatures of the battery cells 26 within the respective retainer assembly 12 and actively balance the battery cells 26 to keep the respective retainer assembly 12 in an optimal condition. In various embodiments, the BMS 140 may be configured to monitor the battery cell voltages, actively balance the battery cells 26, monitor a battery cell temperature, monitor a local board temperature, be capable of local isolated communication with the computing system 64, receive data and information from the computing system 64 for addressing the specific retainer assembly 12, and/or provide any other function.

In various instances, the BMS 140 may include one or more processor-based devices, such as a given controller or computing device or any suitable combination of controllers or computing devices. Thus, in several embodiments, the BMS 140 may include one or more processor(s) 142, and associated memory device(s) 144 configured to perform a variety of computer-implemented functions. As used herein, the term “processor” refers not only to integrated circuits referred to in the art as being included in a computer, but also refers to a controller, a microcontroller, a microcomputer, a programmable logic circuit (PLC), an application specific integrated circuit, and other programmable circuits. Additionally, the memory device(s) 144 of the BMS 140 may generally comprise memory element(s) including, but not limited to, a computer-readable medium (e.g., random access memory RAM)), a computer-readable non-volatile medium (e.g., a flash memory), a floppy disk, a compact disk-read only memory (CD-ROM), a magneto-optical disk (MOD), a digital versatile disk (DVD) and/or other suitable memory elements. Such memory device(s) 144 may generally be configured to store suitable computer-readable instructions that, when implemented by the processor(s) 142, configure the BMS 140 to perform various computer-implemented functions, such as one or more aspects of the methods and algorithms that will be described herein. In addition, the BMS 140 may also include various other suitable components, such as a communications circuit or module, one or more input/output channels, a data/control bus, and/or the like.

Alternatively, the BMS 140 may be configured as a dummy device that may provide data to the network and/or receive any instructions from the computing system 64 of the battery module 10. As such, in some instances, the BMS 140 may be free of any one or more of the components provided herein. For example, in some instances, the BMS 140 may be free of an integrated and/or individual processor(s) 142 and/or memory device(s) 144.

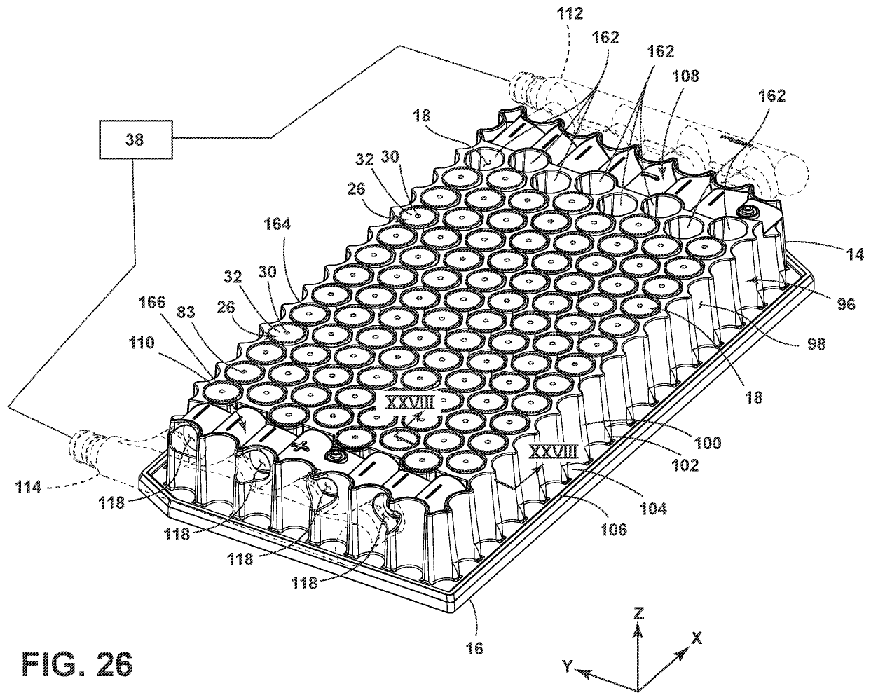

Referring still to FIGS. 15-17, a first manifold 112 may be operably coupled with the well plate 14 and includes a conduit that defines one or more inlet passages fluidly coupled with the conduit. The first manifold 112 may be configured to direct the fluid 54 into the retainer assembly 12 and through one or more channels 42 of the retainer assembly 12. A second manifold 114 may also be coupled with the well plate 14 and includes a conduit and one or more outlet passages configured to receive fluid 54 from the one or more channels 42. As illustrated, the second manifold 114 may be downstream of the first manifold 112 in an X-axis direction. In some instances, the retainer assembly 12 may define a diverter and/or a first array 162 (FIG. 26) of battery cells 26 may be used to divert the fluid 54 from the first manifold 112 to the channels 42. In such instances, the first manifold 112 is a first minimum distance d_{fm} from at least one of the one or more battery cells 26 and the second manifold 114 is a second minimum distance dₛₘ from at least one of the one or more battery cells 26, the second distance dₛₘ being less than the first distance d_{fm}.

As provided herein, during charging and/or discharging of each battery cell 26 within the retainer assembly 12, heat is generated due to an electrochemical reaction and/or ohmic losses. Thus, if the heat of the battery module 10 generated during the charging and discharging process is not effectively removed, heat accumulation may occur. Accordingly, the battery module 10 may also include a cooling system 38 that can be implemented within the retainer assembly 12 for cooling the battery cells 26 included therein. In some embodiments, the cooling system 38 can include a fluid circuit 50 and a pump 52 in fluid communication with the fluid circuit 50 to allow a fluid 54 to be directed through the one or more channels 42. The fluid 54 may be any substance, such as liquid or gas, that is used to reduce or regulate the temperature of a system. In various examples, the fluid 54 may have a high thermal capacity, a high thermal conductivity, a low viscosity, a low-cost, be non-toxic, chemically inert, and/or neither causes nor promotes corrosion of the cooling system 38. In some applications, the fluid 54 may also be an electrical insulator.

In operation, with the actuation of the pump 52, the one or more internal parallel flow channels 42 are fed by the first manifold 112 and the second manifold 114 at each end portion of the retainer assembly 12, which receive and exhaust the fluid 54 through the inlet and outlet openings 116, 118. The flow pattern of the fluid 54 through the one or more channels 42 can be used to create an evenly distributed flow rate for all channels 42, thus minimizing lateral temperature gradients across the module that reduce the cooling effectiveness. In some examples, the inlets of the first manifold 112 and/or the inlets of the second manifold 114 may have a cross-sectional area that is generally equal to the summation of the smallest cross-sectional area of each channel 42 within the well plate 14. In such instances, such a configuration may reduce flow losses during operation.

The rim 66 (FIG. 1) of the module 10 can be a single continuous loop around the exterior of the module 10. The outer sealing border and the inlet/outlet ports 60, 62 can be the only interfaces where a leak would cause fluid 54 to exit the flow cavity and pose a risk to the battery module 10. Since some fluids 54 are electrically conductive, it can be critical that they are kept far away from the current carrying elements of the battery. Since the sealed outer boundary is at the bottom of the module, a leak must deposit a large amount of fluid 54 before the current carrying battery cells 26 will be submerged. The presence of a single critical welded/sealed interface helps decrease the chance of leakage. In some instances, a seal may be placed proximate to the rim 66 (FIG. 1) to further prevent leakage from the module 10. In comparison, a conventional system with direct immersion of each battery cell 26 in an inert fluid 54 must individually seal to each battery cell 26 and thus has many points of failure.

With further reference to FIGS. 15-17, the cooling system 38 may also include a computing system 64 communicatively coupled to one or more components of the battery module 10 to allow the operation of such components to be electronically or automatically controlled by the computing system 64. For instance, the computing system 64 may be communicatively coupled to a pump 52 (e.g., via a communicative link 68) to control the operation thereof. Specifically, in several embodiments, the computing system 64 may be configured to regulate the pump operation such that the fluid 54 is output from the pump 52 as a suitable pressure so as to maintain the circuit pressure within the fluid circuit 50 within a desired or predetermined pressure range (e.g., an operator-selected or prescribed pressure range). For example, in some embodiments, the computing system 64 may be configured to receive pressure-related data from one or more sensors 70 fluidly coupled or otherwise provided in fluid communication with the fluid circuit 50. In such embodiments, the computing system 64 may be configured to monitor various variables of the circuit, such as a circuit pressure of the cooling system 38 based on the sensor feedback provided by the sensor 70 (the communicative links between the sensor 70 and the computing system 64 being omitted to simplify the illustration) and subsequently control the operation of the pump 52 to maintain the circuit pressure within the desired pressure range. Additionally, and/or alternatively, in some embodiments, the sensor 70 may be configured as a flow rate sensor and/or a temperature sensor.

In some embodiments, a heat exchanger 82 may be operably coupled with the fluid circuit 50. The heat exchanger 82 may be any type of device that is configured to transfer heat to and/or from the fluid circuit 50. For example, the heat exchanger may be configured as a shell and tube heat exchanger, a double pipe heat exchanger, a plate heat exchanger, a condenser, an evaporator, a boiler, a combination thereof, and/or any other device that can remove heat from the module 10 disclosed herein.

With further reference to FIGS. 15-17, the pump 52 may also be coupled to a fluid reservoir 76. The reservoir 76 may store additional fluid 54 that may be added to the pumped fluid 54 when the circuit is below a predefined threshold. Additionally, and/or alternatively, the fluid 54 may be circulated from the retainer assembly 12 to the reservoir 76 and back to the one or more channels 42 and/or the fluid circuit 50. Thus, by utilizing additional fluid 54, the temperature of the fluid 54 may be reduced as it enters the inlet of the retainer assembly 12.

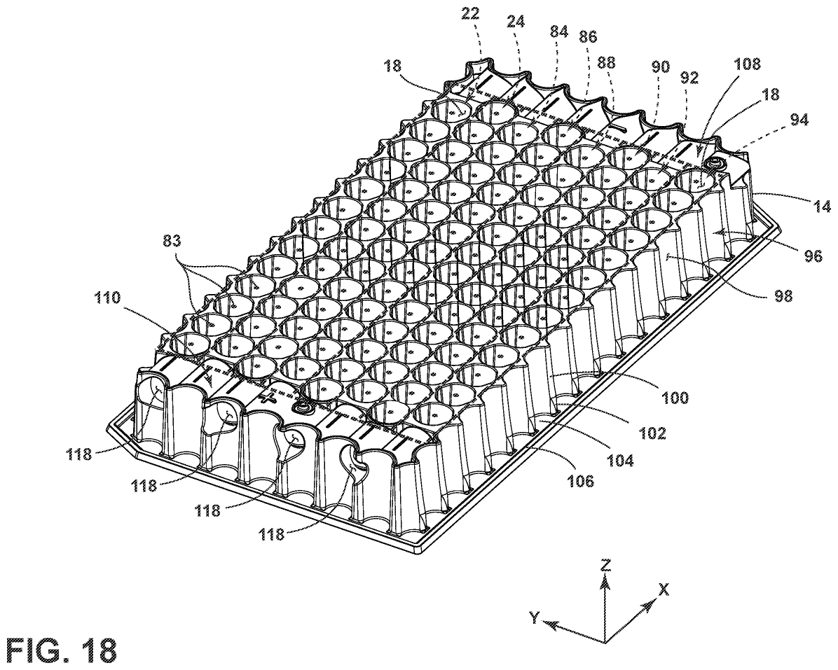

Referring now to FIG. 18, in some embodiments, one or more of battery cell cavities 18 can be positioned in an offset orientation relative to adjacently positioned cavities. For example, as generally described above, a first row 22 of battery cell cavities 18 may have central portions 83 that align in a first direction (i.e., an X-axis direction or a longitudinal direction). An adjacent second row 24 of battery cell cavities 18 may also has central portions 83 that align in the first direction. However, the central portions 83 of each cavity 18 in the first row 22 are offset from the central portions 83 of each cavity 18 in the second row 24 in a second, perpendicular direction (i.e., Y-axis direction or a latitudinal direction). As used herein, the central portions 83 of each cavity may be a geometric central point or an area that includes a plurality of points in which a first line extending across the cavity intersects a second line also extending across the cavity.

As further illustrated in FIG. 18, a third row 84 of battery cell cavities 18 may be positioned on an opposing side of the second row 24 from the first row 22. The third row 84 of battery cell cavities 18 also has central portions 83 that align in the first direction. However, the central portions 83 of each cavity 18 in the third row 84 are offset from the central portions 83 of each cavity 18 in the second row 24 in the second, perpendicular direction and may be aligned with the first row 22. A fourth row 86 of battery cell cavities 18 may be positioned on an opposing side of the third row 84 from the second row 24. The fourth row 86 of battery cell cavities 18 also has central portions 83 that align in the first direction. However, the central portions 83 of each cavity 18 in the fourth row 86 are offset from the central portions 83 of each cavity 18 in the third row 84 in the second, perpendicular direction and may be aligned with the second row 24. A fifth row 88 of battery cell cavities 18 may be positioned on an opposing side of the fourth row 86 from the third row 84. The fifth row 88 of battery cell cavities 18 also has central portions 83 that align in the first direction. However, the central portions 83 of each cavity 18 in the fifth row 88 are offset from the central portions 83 of each cavity 18 in the fourth row 86 in the second, perpendicular direction and may be aligned with the third row 84. A sixth row 90 of battery cell cavities 18 may be positioned on an opposing side of the fifth row 88 from the fourth row 86. The sixth row 90 of battery cell cavities 18 also has central portions 83 that align in the first direction. However, the central portions 83 of each cavity 18 in the sixth row 90 are offset from the central portions 83 of each cavity 18 in the fifth row 88 in the second, perpendicular direction and may be aligned with the fourth row 86. A seventh row 92 of battery cell cavities 18 may be positioned on an opposing side of the sixth row 90 from the fifth row 88. The seventh row 92 of battery cell cavities 18 also has central portions 83 that align in the first direction. However, the central portions 83 of each cavity 18 in the seventh row 92 are offset from the central portions 83 of each cavity 18 in the sixth row 90 in the second, perpendicular direction and may be aligned with the fifth row 88. An eighth row 94 of battery cell cavities 18 may be positioned on an opposing side of the seventh row 92 from the sixth row 90. The eighth row 94 of battery cell cavities 18 also has central portions 83 that align in the first direction. However, the central portions 83 of each cavity 18 in the eighth row 94 are offset from the central portions 83 of each cavity 18 in the seventh row 92 in the second, perpendicular direction and may be aligned with the sixth row 90. It will be appreciated that while eight rows (e.g., 22, 24, 84, 86, 88, 90, 92, 94) are illustrated, the retainer assembly 12 may include any number of rows (zero to any practicable amount) without departing from the scope of the present disclosure.

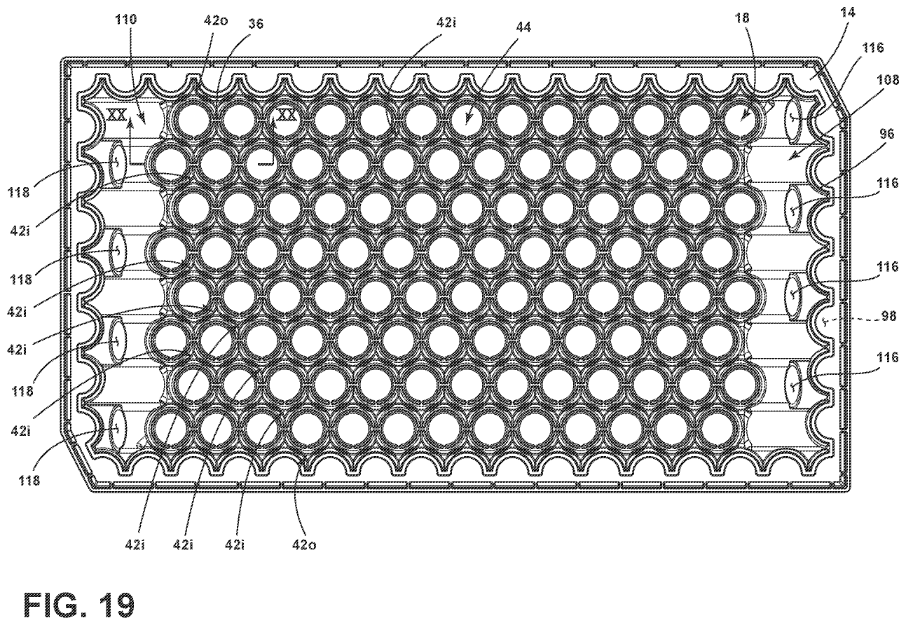

Referring now to FIGS. 19-22, as described herein, one or more ribs 36 may extend between at least two battery cell cavities 18 within a common row (e.g., 22, 24, 84, 86, 88, 90, 92, 94). The one or more ribs 36 may be configured to contact the substrate 16 and/or seal any openings between two adjacent battery cell cavities 18 within a common row (e.g., 22, 24, 84, 86, 88, 90, 92, 94). As such, one or more channels 42 are defined between an interior side of the well plate 14 and an upper side of the substrate 16. In some instances, the battery cell cavities 18 and/or the ribs 36 may define one or more separate inboard channels 42ᵢ. In addition, the outer rows 22, 94 of battery cell cavities 18, which in the illustrated embodiment are the first row 22 and the eighth row 94, in combination with the outer wall 96 define perimeter channels 42ₒ. In various examples, the coves 98 of the outer wall 96 may be offset from the outer rows 22, 94 of battery cell cavities 18 in the Y-axis direction. As such, the perimeter channels 42ₒ may have a volume and/or flow pattern that is generally similar to the inboard channels 42ᵢ. In such instances, a more consistent cooling pattern of the batteries may be accomplished.

Referring still to FIGS. 19-24, in various embodiments, a center portion of the two adjacent battery cell cavities 18 may be aligned along an alignment axis Aₐ within a common row (e.g., 22, 24, 84, 86, 88, 90, 92, 94). The center portions 83a, 83b may be separated by a first distance d₁. Moreover, the center portion 83a of the first battery cell cavity 18 within the first row (e.g., 22, 24, 84, 86, 88, 90, 92, 94) may be separated by a second distance d₂ from a center portion 83c of an adjacent battery cell cavity 18 of an adjacent row (e.g., 22, 24, 84, 86, 88, 90, 92, 94). Likewise, the center portion 83b of the second battery cell cavity 18 within the first row (e.g., 22, 24, 84, 86, 88, 90, 92, 94) may be separated by a third distance ds from the center portion 83c of the battery cell cavity 18 of the adjacent row (e.g., 22, 24, 84, 86, 88, 90, 92, 94). In various embodiments, the first distance d₁ may be less than the second distance d₂ and/or the third distance ds. Moreover, in some examples, the second and third distances d₂, ds may be generally equal to one another.

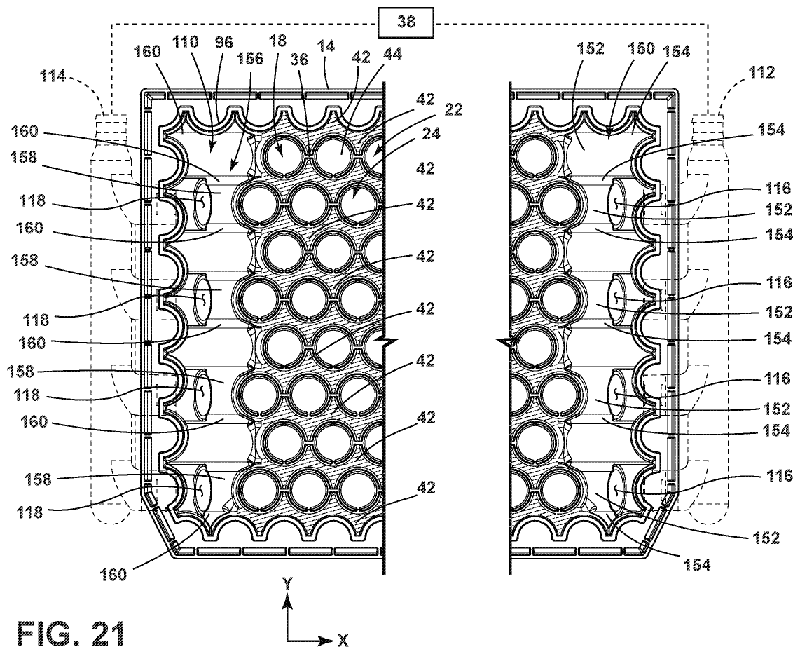

Referring further to FIGS. 19-24, in various examples, the inlet plenum 108 may be operably coupled with the first manifold 112 and the outlet plenum 110 may be operably coupled with the second manifold 114. As provided herein, the inlet plenum 108 may be configured to direct the cooling fluid 54 into one or more channels 42 defined by the well plate 14 and the substrate 16. The outlet plenum 110 may be configured to direct cooling fluid 54 from the one or more channels 42 to a cooling system 38 so that the battery module 10 may be capable of rejecting heat. The fluid 54 may be directed through one or more channels 42 that can be defined between the well plate 14 and the substrate 16 between the first manifold 112 and the second manifold 114. The one or more channels 42 may generally encompass the areas between the well plate 14 and the substrate 16 that are offset from the battery cell cavities 18 18. As provided above, each row (e.g., 22, 24, 84, 86, 88, 90, 92, 94) of battery cell cavities 18 may be offset from the adjacent rows, which is generally illustrated by the shaded regions in FIG. 21. Accordingly, the one or more channels 42 may include a plurality of curved sections around each of the battery cell cavities 18. As such, in some embodiments, a practicable and/or desirable flow path.

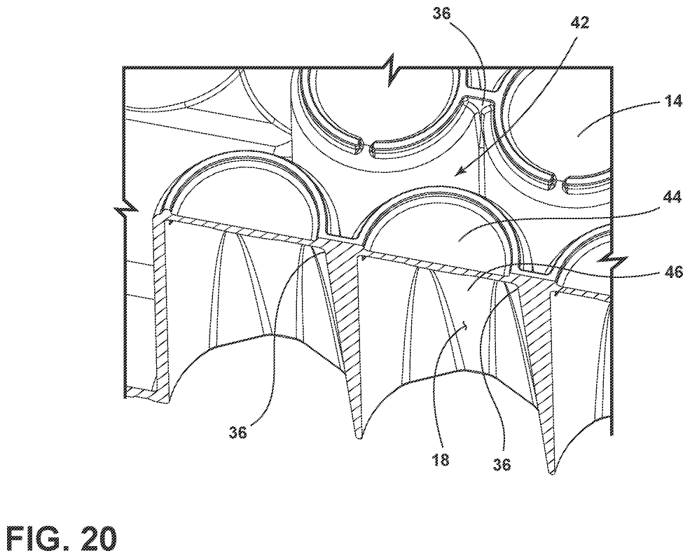

With further reference to FIGS. 19-24, the inlet plenum 108 may include one or more openings 116 and a body 150 extending from the outer wall 96 towards the one or more battery cell cavities 18. In various examples, the body 150 may define a plurality of curved segments 152 that extend in a direction that is generally perpendicular to an alignment axis Aₐ of the one or more battery cell cavities 18. The curved segments 152 may be capable of providing additional structure that prevents bending of the well plate 14 as the fluid 54 is directed into the retainer assembly 12. In some examples, the body 150 may include an equal number of curved segments 152 to rows (e.g., 22, 24, 84, 86, 88, 90, 92, 94) of battery cell cavities 18. For instance, in the examples illustrated in FIGS. 20-22, the retainer assembly 12 includes eight rows 22, 24, 84, 86, 88, 90, 92, 94 of battery cell cavities 18 and eight curved segments 152. However, it will be appreciated that in other examples, the number of rows of battery cell cavities 18 may be varied from the number of curved segments 152 of the inlet plenum 108.

Furthermore, the one or more openings 116 may be generally aligned (or offset) from the curved segments 152. In some examples, the one or more battery cell cavities 18 include a first row 22 of battery cell cavities 18 and a second row 24 of battery cell cavities 18 each generally extending along an X-axis direction with the second row 24 of battery cell cavities 18 being offset from the first row 22 of battery cell cavities 18 in a Y-axis direction. The opening 116 may be generally offset from the first row 22 of battery cell cavities 18 in the X-axis direction and aligned with the second row 24 of battery cell cavities 18 in the X-axis direction.

A ridge 154 may be formed or present at each opposing side portion of each curved segment 152 that extends at least partially between an opening 116 of the inlet plenum 108 and at least one of the one or more battery cell cavities 18. In various examples, one or more of the ridges 154 may be generally aligned with a channel 42 of the retainer assembly 12. For example, a first ridge 154 on a first side portion of a curved segment 152 may be aligned with a channel 42 on the first side of the second row 24 of battery cell cavities 18 and a second ridge 154 on a second side portion of a curved segment 152 may be aligned with a channel 42 on the second side of the second row 24 of battery cell cavities 18.

The outlet plenum 110 may one or more openings 118 and a body 156 extending from the outer wall 96 towards the one or more battery cell cavities 18. In various examples, the body 156 may define a plurality of curved segments 158 that extend in a direction that is generally perpendicular to an alignment axis Aₐ of the one or more battery cell cavities 18. In some examples, the body 156 may include an equal number of curved segments 158 to rows (e.g., 22, 24, 84, 86, 88, 90, 92, 94) of battery cell cavities 18. For instance, in the examples illustrated in FIGS. 19-22, the retainer assembly 12 includes eight rows (e.g., 22, 24, 84, 86, 88, 90, 92, 94) of battery cell cavities 18 and eight curved segments 158. However, it will be appreciated that in other examples, the number of rows (e.g., 22, 24, 84, 86, 88, 90, 92, 94) of battery cell cavities 18 may be varied from the number of curved segments 158 of the outlet plenum 110.

Similar to the inlet plenum 108, the one or more openings 118 of the outlet plenum 110 may be generally aligned (or offset) from the curved segments 158. In some examples, the one or more battery cell cavities 18 include a first row (e.g., 22, 24, 84, 86, 88, 90, 92, 94) of battery cell cavities 18 and a second row (e.g., 22, 24, 84, 86, 88, 90, 92, 94) of battery cell cavities 18 each generally extending along an X-axis direction with the second row (e.g., 22, 24, 84, 86, 88, 90, 92, 94) of battery cell cavities 18 being offset from the first row (e.g., 22, 24, 84, 86, 88, 90, 92, 94) of battery cell cavities 18 in a Y-axis direction. The opening 118 may be generally aligned with the first row (e.g., 22, 24, 84, 86, 88, 90, 92, 94) of battery cell cavities 18 in the X-axis direction and offset from the second row (e.g., 22, 24, 84, 86, 88, 90, 92, 94) of battery cell cavities 18 in the X-axis direction. As such, the openings 116 of the inlet plenum 108 may be offset from the openings 118 of the outlet plenum 110.

A ridge 160 may be formed or present at each opposing side portion of each curved segment 158 that extends at least partially between an opening 118 of the outlet plenum 110 and at least one the one or more battery cell cavities 18. In various examples, one or more of the ridges 160 may be generally aligned with a channel 42 of the retainer assembly 12. For example, a first ridge 160 on a first side portion of a curved segment 158 may be aligned with a channel 42 on the first side of the second row (e.g., 22, 24, 84, 86, 88, 90, 92, 94) of battery cell cavities 18 and a second ridge 160 on a second side portion of a curved segment 158 may be aligned with a channel 42 on the second side of the second row (e.g., 22, 24, 84, 86, 88, 90, 92, 94) of battery cell cavities 18.

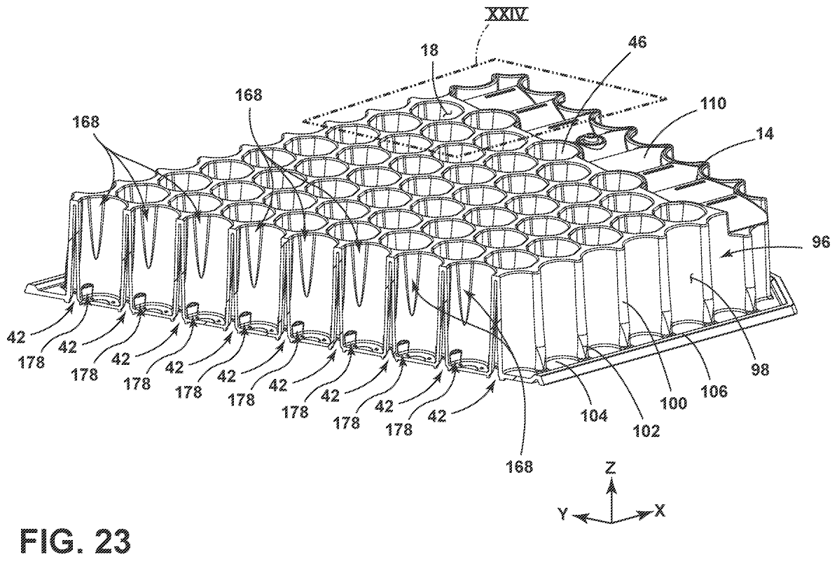

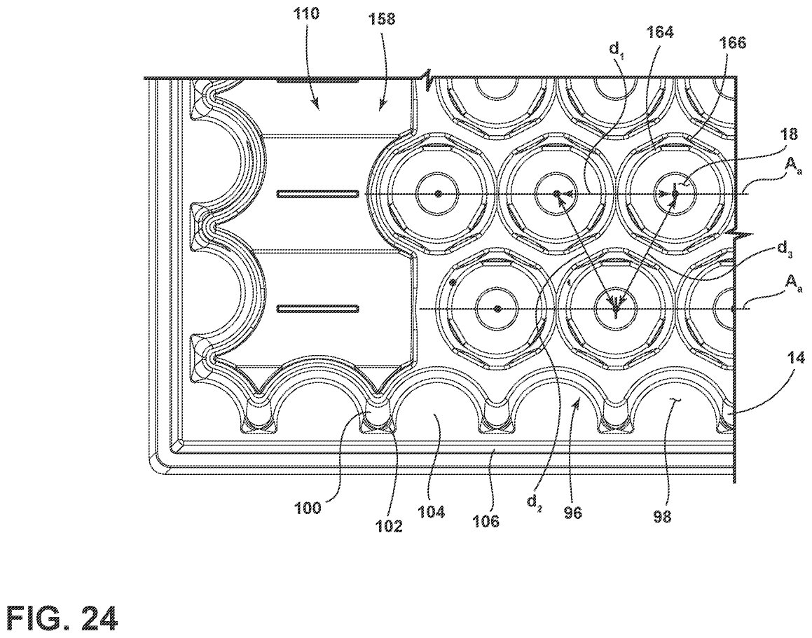

Referring to FIGS. 23-25, in some embodiments, the battery cell cavities 18 can have no draft and include a side wall 46 that may be less than 2 mm thick, less than 1.5 mm thick, less than 1 mm thick, or less than 0.5 mm thick. In other embodiments, the wall thickness of the cavity walls within the well plate 14 can be about 2 mm in thickness and have a draft of 1-2 degrees for ease of molding, injection molding, and/or ejection of the well plate 14 from a mold. In some instances, as the wall thickness increases, the injection pressure required to fill an injection mold cavity reduces and thus enables the use of smaller machines with a lower tonnage.

In various embodiments, the battery cell cavities 18 may include a protrusion 168 therein. In embodiments in which the well plate 14 is injection molded, the protrusion 168 may be configured to allow for a thicker core or tool to the positioned between adjacent cavities. As such, the manufacturability of the well plate 14 may be increased. In addition, the protrusions 168 may allow for a non-continuous surface thereby further increasing the rigidity of each battery cell cavity 18.

In some embodiments, the battery cell cavities 18 may also define a notch 178 in a bottom portion thereof. The notch 178 may be configured to compressively maintain the battery cell 26 within the battery cell 26 cavity and/or define a standoff height between the battery and the bottom portion of the battery cell cavity 18.

Referring to FIGS. 26-28, in some embodiments, an upstream array 162 of battery cell cavities 18 may be empty while one or more downstream cavities may house a battery cell 26. For example, in the illustrated example, the upstream battery cell cavities 18 that are aligned with the openings 118 of the inlet plenum 108 may be free of a battery cell 26 while the remaining cavities each include a battery cell 26. In some instances, the upstream array 162 of battery cell cavities 18 may be configured as diverters that direct the fluid 54 from the inlet plenum 108 into each of the channels 42. In some instances, due to the initial contact of the fluid 54 with the upstream array 162 of battery cell cavities 18, the cooling characteristics of any battery that would be placed therein may differ from the remaining cells by a noticeable amount. As such, by maintained the upstream array 162 free of battery cells 26, the temperature characteristics of the battery cells 26 may be maintained in a more consistent profile. In other embodiments, any other diverter may be positioned upstream of the battery cell cavities 18 in order to divert the fluid 54 to the appropriate channels 42.

In various embodiments, a perimeter geometry 164 of the battery cell 26 is varied from a rim geometry 166 of the one or more battery cell cavities 18. For example, the perimeter geometry 164 of the battery cell 26 may be generally circular, and the rim geometry 166 of the one or more battery cell cavities 18 may be non-circular. Alternatively, the perimeter geometry 164 of the battery cell 26 may be generally rectangular, and the rim geometry 166 of the one or more battery cell cavities 18 may be non-rectangular and so on. It will be appreciated that each of the perimeter geometry 164 of the battery cell 26 and the rim geometry 166 of the one or more battery cell cavities 18 may be any defined shape without departing from the scope of the present disclosure. In addition, it will be appreciated that, in some embodiments, the perimeter geometry 164 of the battery cells 26 may be varied relative to one another within the battery module 10. Likewise, it will be appreciated that, in some embodiments, the rim geometry 166 of the one or more battery cell cavities 18 may be varied relative to one another along the well plate 14.

Referring further to FIGS. 26-29, in some embodiments, a bottom wall 44 of one or more of the battery cell cavities 18 may define a coupling portion 170. Likewise, the outer wall 96 may define a joining portion 172. In various instances, the joining portion 172 having a thickness that is varied from a thickness of the coupling portion 170. As provided herein, the well plate 14 is configured to couple with the substrate 16 through any practicable method. For example, an adhesive 78 (such as epoxy) may be positioned between the coupling portions 170 and/or the joining portions 172 and the substrate 16 to bond the components to one another. In other examples, the components may be welded to one another.

In some examples, once the well plate 14 and the joined with one another, a chamber 174 is generally bounded by the bottom wall 44 of the cavity, the coupling portion 170, and the substrate 16. To allow access to the chamber 174, the coupling portion 170 defines an aperture 176. As provided herein, at least two battery cell cavities 18 may define a first row (e.g., 22, 24, 84, 86, 88, 90, 92, 94) of battery cell cavities 18 aligned in the X-axis direction that at least partially define a first channel 42 on a first side of the at least two battery cell cavities 18 and a second channel 42 on a second, opposing side of the at least two battery cell cavities 18. The aperture 176 of a first battery cell cavity 18 of the at least two battery cell cavities 18 and the aperture 176 of a second battery cell cavity 18 of the at least two battery cell cavities 18 are positioned within a common channel 42.

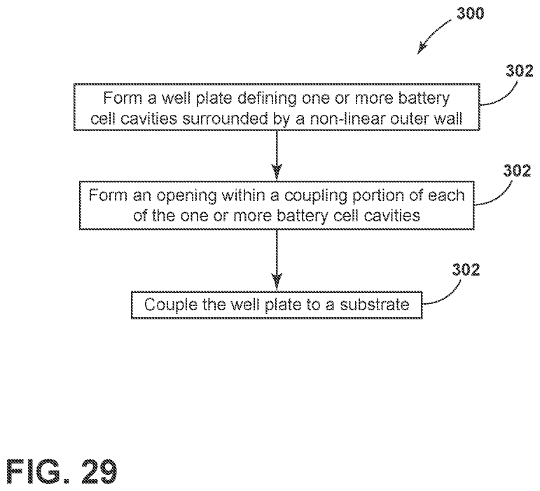

Referring now to FIG. 29, a flow diagram of a method 300 for manufacturing the battery module is illustrated in accordance with aspects of the present subject matter. In general, the method 300 will be described herein with reference to the battery module 10 shown in FIGS. 15-28, as well as the various system components shown in these figures. However, it should be appreciated that the disclosed method 300 may be implemented with battery modules 10 having any other suitable configuration and/or within systems having any other suitable system configuration. In addition, although FIG. 29 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

Referring now to FIG. 29, at (302), the method can include forming a well plate defining one or more battery cell cavities that may be surrounded by a non-linear outer wall. The one or more battery cell cavities can each define a coupling portion. Moreover, the outer wall defines a joining portion with the joining portion having a thickness that is varied from a thickness of the coupling portion. For example, the joining portion may have a thickness that is generally greater than the thickness of the coupling portion. Alternatively, the joining portion may have a thickness that is generally less than the thickness of the coupling portion. However, in other examples, the thickness may be generally equal without departing from the scope of the present disclosure.

In some embodiments, the one or more battery cell cavities can include a first row of battery cell cavities that generally extend along an X-axis direction. A rib can extend between at least a first battery cell cavity and a second battery cell cavity within the one or more battery cell cavities. A first channel can be defined on a first side of the first row of battery cell cavities and a second channel can be defined on a second side of the first row of battery cell cavities. In such instances, the rib can prevent flow from the first channel to the second channel.

At (304), the method 300 includes coupling the well plate to a substrate. The well plate may be coupled to the substrate through any practicable method. For example, an adhesive (such as epoxy) may be positioned between the well plate and the substrate to bond the components to one another. In other examples, the components may be welded to one another. In such instances, the coupling portion and the joining portions of the well plate may be operably coupled with the substrate. In other embodiments, the well plate may be joined to the substrate through other practicable methods, such as through a transmission laser welding process.

At step (306), the method 300 includes forming an aperture within the coupling portion of each of the one or more battery cell cavities. In addition, coupling the well plate to the substrate forms a chamber between each of the one or more battery cell cavities and the substrate. The aperture of the one or more battery cell cavities within a row of battery cells can allow fluid movement from the chamber between each of the one or more battery cell cavities and the substrate to a common channel.

A variety of advantages may be derived from the use of the present disclosure. For example, the use of the system and method provided herein can lead to advantages that include, but are not limited to cost, strength, durability, life cycle cost, marketability, appearance, packaging, size, serviceability, weight, manufacturability, ease of assembly, etc. For instance, the battery module provided herein may provide superior heat transfer ability compared to conventional battery modules that allow for safe and low degradation operation at high power discharge rates. In some implementations, the battery module may be formed from an all-plastic structure that provides a mechanical, thermal, electrical, fluid solution with scaled manufacturing processes. In several examples, the plastic retainer assembly providing herein is unique in that plastic is usually ignored for heat transfer applications because of its low thermal conductivity. Further, in examples in which the retainer assembly is formed from plastic materials, a possibility of shorting battery cells to a metal frame is negated as the insulator from the battery cell to the cooling fluid is a plastic shell. Further, the retainer assembly provided herein includes minimal parts leading to a minimal number of joints that are sealed. By minimizing the number of joints, the manufacturing costs may be reduced, and the reliability of the battery module may be increased due to lower instances of product failure.

Aspects of the invention(s) are provided by the subject matter of the following clauses, which are intended to cover all suitable combinations unless dictated otherwise based on logic or the context of the clauses and/or associated figures and description:

A battery module, comprising: a retainer assembly including a well plate operably coupled with a substrate, wherein the well plate defines one or more battery cell cavities on an exterior side of the well plate, and wherein one or more channels are defined between an interior side of the well plate and an upper side of the substrate; one or more battery cells positioned within the one or more battery cell cavities; a first manifold defining one or more fluid outlets configured to direct a fluid through the one or more channels, wherein each of the one or more channels includes a non-uniform cross section in a longitudinal direction; a second manifold defining one or more fluid inlet passages configured to receive fluid from the one or more channels, wherein the second manifold is downstream of the first manifold in an X-axis direction, and wherein the first manifold is a first minimum distance from at least one of the one or more battery cells and the second manifold is a second minimum distances from at least one of the one or more battery cells, the second distance being less than the first distance; and a cooling system fluidly coupling the second manifold to the first manifold.

The battery module of one or more of these clauses, wherein the well plate defines an outer wall that surrounds the one or more battery cell cavities, and wherein the outer wall is non-planar in shape.

The battery module of one or more of these clauses, wherein the non-planar outer wall defines one or more of semi-cylindrical coves.

The battery module of one or more of these clauses, wherein each of the semi-cylindrical coves are offset from a row of battery cell cavities extending in a generally linear direction along the X-axis direction.

The battery module of one or more of these clauses, wherein the one or more battery cell cavities includes a coupling portion extending from a bottom wall thereof and configured to couple with the substrate, wherein the coupling portion defines an aperture.

The battery module of one or more of these clauses, wherein at least two battery cell cavities of the one or more battery cell cavities define a first row of battery cell cavities aligned in the X-axis direction that at least partially define a first channel on a first side of the at least two battery cell cavities and a second channel on a second, opposing side of the at least two battery cell cavities, and wherein the aperture of a first battery cell cavity of the at least two battery cell cavities and the aperture of a second battery cell cavity of the at least two battery cell cavities are positioned within a common channel.

The battery module of one or more of these clauses, wherein the at least two battery cell cavities of the first row of battery cell cavities each include a center portion aligned along an alignment axis, the center portions of the at least two battery cell cavities separated by a first distance, and wherein the center portions of the at least two battery cell cavities are separated by a second distance from an alignment axis of a second, adjacent row of battery cell cavities, the first distance being less than the second distance.

The battery module of one or more of these clauses, wherein a perimeter geometry of the battery cell is varied from a rim geometry of the one or more battery cell cavities.

The battery module of one or more of these clauses, further comprising: a sensor operably coupled with the cooling system and configured to output data indicative of at least one of a fluid temperature, a fluid flow rate, a fluid pressure, or a fluid volume within the cooling system.

The battery module of one or more of these clauses, further comprising: one or more ribs each extending between at least two battery cell cavities, and wherein the one or more ribs are configured to contact the substrate.

A method of manufacturing a battery module having a cooling system, the method comprising: forming a well plate defining one or more battery cell cavities surrounded by a non-linear outer wall, wherein the one or more battery cell cavities each define a coupling portion, and wherein the outer wall defines a joining portion, the joining portion having a thickness that is varied from a thickness of the coupling portion; and coupling the well plate to a substrate.

The method of one or more of these clauses, further comprising: forming an aperture within the coupling portion of each of the one or more battery cell cavities, and wherein coupling the well plate to the substrate forms a chamber between each of the one or more battery cell cavities and the substrate.

The method of one or more of these clauses, wherein the one or more battery cell cavities include a first row of battery cell cavities that generally extend along an X-axis direction, and wherein a rib extends between at least a first battery cell cavity and a second battery cell cavity within the one or more battery cell cavities.

The method of one or more of these clauses, wherein a first channel is defined on a first side of the first row of battery cell cavities and a second channel is defined on a second side of the first row of battery cell cavities, and wherein the rib prevents flow from the first channel to the second channel.

The method of one or more of these clauses, wherein the aperture of the one or more battery cell cavities within a row of battery cells allows fluid movement from the chamber between each of the one or more battery cell cavities and the substrate to a common channel.

A retainer assembly for a battery module, the retainer assembly comprising: a substrate; and a well plate operably coupled with the substrate, wherein the well plate defines one or more battery cell cavities on an exterior side of the well plate, the one or more battery cell cavities defining first and second channels between an interior side of the one or more battery cell cavities and the substrate, and wherein an outer wall has a non-planar shape that surrounds at least the first and second channels.

The retainer assembly for a battery module of one or more of these clauses, wherein the well plate further defines an inlet plenum having a curved top portion, the curved top portions extending in a direction that is generally perpendicular to an alignment axis of the one or more battery cell cavities, and wherein the inlet plenum defines one or more inlets configured to accept a manifold for directing fluid through the first and second channels.

The retainer assembly for a battery module of one or more of these clauses, wherein the inlet plenum defines a first ridge that extends at least partially between an opening of the inlet plenum and at least one of the one or more battery cell cavities, and wherein the first ridge is generally aligned with the first channel.

The retainer assembly for a battery module of one or more of these clauses, wherein the one or more battery cell cavities include a first row of battery cell cavities and a second row of battery cell cavities each generally extending along an X-axis direction, wherein the second row of battery cell cavities is offset from the first row of battery cell cavities in a Y-axis direction, and wherein an opening is generally offset from the first row of battery cell cavities in the X-axis direction and aligned with the second row of battery cell cavities in the X-axis direction.

The retainer assembly for a battery module of one or more of these clauses, wherein the outer wall of the well plate defines one or more semi-cylindrical coves, and wherein the one or more battery cell cavities have a varied geometry from the one or more semi-cylindrical coves.

It will be understood by one having ordinary skill in the art that construction of the described invention and other components is not limited to any specific material. Other exemplary examples of the invention disclosed herein may be formed from a wide variety of materials unless described otherwise herein.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

Furthermore, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably couplable” to each other to achieve the desired functionality. Some examples of operably couplable include, but are not limited to, physically mateable, physically interacting components, wirelessly interactable, wirelessly interacting components, logically interacting, and/or logically interactable components.

It is also important to note that the construction and arrangement of the elements of the invention as shown in the examples are illustrative only. Although only a few examples of the present innovations have been described in detail in this disclosure, those skilled in the art who review this disclosure will readily appreciate that many modifications are possible (e.g., variations in sizes, dimensions, structures, shapes, and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connectors or other elements of the system may be varied, the nature or number of adjustment positions provided between the elements may be varied. It should be noted that the elements and/or assemblies of the system might be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary examples without departing from the spirit of the present innovations.

It will be understood that any described processes or steps within described processes may be combined with other disclosed processes or steps to form structures within the scope of the present invention. The exemplary structures and processes disclosed herein are for illustrative purposes and are not to be construed as limiting. In addition, variations and modifications can be made on the aforementioned structures and methods without departing from the concepts of the present invention and such concepts are intended to be covered by the following claims unless these claims by their language expressly state otherwise.

What is claimed is:

1. A battery module, comprising:
a retainer assembly including a well plate operably coupled with a substrate, wherein the well plate defines one or more battery cell cavities on an exterior side of the well plate, and wherein one or more channels are defined between an interior side of the well plate and an upper side of the substrate;
one or more battery cells positioned within the one or more battery cell cavities;
a first manifold defining one or more fluid outlets configured to direct a fluid through the one or more channels, wherein each of the one or more channels includes a non-uniform cross section in a longitudinal direction;
a second manifold defining one or more fluid inlet passages configured to receive fluid from the one or more channels, wherein the second manifold is downstream of the first manifold in an X-axis direction, and wherein the first manifold is a first minimum distance from at least one of the one or more battery cells and the second manifold is a second minimum distances from at least one of the one or more battery cells, the second distance being less than the first distance; and
a cooling system fluidly coupling the second manifold to the first manifold.

2. The battery module of claim 1, wherein the well plate defines an outer wall that surrounds the one or more battery cell cavities, and wherein the outer wall is non-planar in shape.

3. The battery module of claim 2, wherein the non-planar outer wall defines one or more of semi-cylindrical coves.

4. The battery module of claim 3, wherein each of the semi-cylindrical coves are offset from a row of battery cell cavities extending in a generally linear direction along the X-axis direction.

5. The battery module of claim 1, wherein the one or more battery cell cavities includes a coupling portion extending from a bottom wall thereof and configured to couple with the substrate, wherein the coupling portion defines an aperture.

6. The battery module of claim 5, wherein at least two battery cell cavities of the one or more battery cell cavities define a first row of battery cell cavities aligned in the X-axis direction that at least partially define a first channel on a first side of the at least two battery cell cavities and a second channel on a second, opposing side of the at least two battery cell cavities, and wherein the aperture of a first battery cell cavity of the at least two battery cell cavities and the aperture of a second battery cell cavity of the at least two battery cell cavities are positioned within a common channel.

7. The battery module of claim 6, wherein the at least two battery cell cavities of the first row of battery cell cavities each include a center portion aligned along an alignment axis, the center portions of the at least two battery cell cavities separated by a first distance, and wherein the center portions of the at least two battery cell cavities are separated by a second distance from an alignment axis of a second, adjacent row of battery cell cavities, the first distance being less than the second distance.

8. The battery module of claim 1, wherein a perimeter geometry of the battery cell is varied from a rim geometry of the one or more battery cell cavities.

9. The battery module of claim 1, further comprising:
a sensor operably coupled with the cooling system and configured to output data indicative of at least one of a fluid temperature, a fluid flow rate, a fluid pressure, or a fluid volume within the cooling system.

10. The battery module of claim 1, further comprising:
one or more ribs each extending between at least two battery cell cavities, and wherein the one or more ribs are configured to contact the substrate.

11. A method of manufacturing a battery module having a cooling system, the method comprising:
forming a well plate defining one or more battery cell cavities surrounded by a non-linear outer wall, wherein the one or more battery cell cavities each define a coupling portion, and wherein the outer wall defines a joining portion, the joining portion having a thickness that is varied from a thickness of the coupling portion; and
coupling the well plate to a substrate.

12. The method of claim 11, further comprising:
forming an aperture within the coupling portion of each of the one or more battery cell cavities, and wherein coupling the well plate to the substrate forms a chamber between each of the one or more battery cell cavities and the substrate.

13. The method of claim 11, wherein the one or more battery cell cavities include a first row of battery cell cavities that generally extend along an X-axis direction, and wherein a rib extends between at least a first battery cell cavity and a second battery cell cavity within the one or more battery cell cavities.

14. The method of claim 13, wherein a first channel is defined on a first side of the first row of battery cell cavities and a second channel is defined on a second side of the first row of battery cell cavities, and wherein the rib prevents flow from the first channel to the second channel.

15. The method of claim 12, wherein the aperture of the one or more battery cell cavities within a row of battery cells allows fluid movement from the chamber between each of the one or more battery cell cavities and the substrate to a common channel.

16. A retainer assembly for a battery module, the retainer assembly comprising:
a substrate; and
a well plate operably coupled with the substrate, wherein the well plate defines one or more battery cell cavities on an exterior side of the well plate, the one or more battery cell cavities defining first and second channels between an interior side of the one or more battery cell cavities and the substrate, and wherein an outer wall has a non-planar shape that surrounds at least the first and second channels.

17. The retainer assembly of claim 16, wherein the well plate further defines an inlet plenum having a curved top portion, the curved top portions extending in a direction that is generally perpendicular to an alignment axis of the one or more battery cell cavities, and wherein the inlet plenum defines one or more inlets configured to accept a manifold for directing fluid through the first and second channels.

18. The retainer assembly of claim 17, wherein the inlet plenum defines a first ridge that extends at least partially between an opening of the inlet plenum and at least one of the one or more battery cell cavities, and wherein the first ridge is generally aligned with the first channel.

19. The retainer assembly of claim 16, wherein the one or more battery cell cavities include a first row of battery cell cavities and a second row of battery cell cavities each generally extending along an X-axis direction, wherein the second row of battery cell cavities is offset from the first row of battery cell cavities in a Y-axis direction, and wherein an opening is generally offset from the first row of battery cell cavities in the X-axis direction and aligned with the second row of battery cell cavities in the X-axis direction.

20. The retainer assembly of claim 16, wherein the outer wall of the well plate defines one or more semi-cylindrical coves, and wherein the one or more battery cell cavities have a varied geometry from the one or more semi-cylindrical coves.
